(19) United States
(12) Patent Application Publication
(10) Pub. No.: US 2025/0236694 A1
(43) Pub. Date: Jul. 24, 2025

(54) SYNTHESIS OF HIGHLY BRANCHED POLYMERS VIA HIGH THROUGHPUT SCREENING

(71) Applicants: The Regents of the University of California, Oakland, CA (US); The Mitsubishi Chemical Corporation, Tokyo (JP)

(72) Inventors: Mizhi Xu, Santa Barbara, CA (US); Kazuhisa Iwaso, Goleta, CA (US); Declan Shannon, Traverse City, MI (US); Morgan W. Bates, Santa Barbara, CA (US); Hengbin Wang, Santa Barbara, CA (US); Shunsuke Chatani, Tokyo (JP); Craig J. Hawker, Santa Barbara, CA (US)

(73) Assignees: The Regents of the University of California, Oakland, CA (US); The Mitsubishi Chemical Corporation, Tokyo (JP)

(21) Appl. No.: 19/032,863

(22) Filed: Jan. 21, 2025

Related U.S. Application Data
(60) Provisional application No. 63/623,046, filed on Jan. 19, 2024.

(51) Int. Cl. C08F 220/18; C08F 2/38; C08F 220/06; C08F 222/10; C09J 7/38

(52) U.S. Cl. CPC C08F 220/1804; C08F 2/38; C08F 220/06; C08F 222/102; C09J 7/385; C08F 2438/03

(57) ABSTRACT

Efficient condition optimization for the synthesis of highly branched polymers using high throughput screening has been developed. This innovation allows rapid production of soluble, highly branched polymers with different properties (molecular weight, degree of branching, etc.). Moreover, this versatile technique has the potential to be extended to other monomer/linker systems and polymerization techniques such as emulsion or suspension polymerization, anionic polymerization and continuous flow synthesis. A resin composition is further disclosed.

### CROSS REFERENCE TO RELATED APPLICATIONS

This application claims the benefit under 35 U.S.C. Section 119(e) of the following co-pending and commonly-assigned application:
U.S. Provisional Application Ser. No. 63/623,046, filed on Jan. 19, 2024, by Mizhi Xu, Kazuhisa Iwaso, Declan Shannon, Morgan W. Bates. Hengbin Wang, Shunsuke Chatani, and Craig J. Hawker, entitled “SYNTHESIS OF HIGHLY BRANCHED POLYMERS VIA HIGH THROUGHPUT SCREENING,” attorneys' docket number G&C 30794.0853USP1 (30794.0853USP1);
which application is incorporated by reference herein.

### BACKGROUND OF THE INVENTION

### 1. Field of the Invention

This invention relates generally to the synthesis of highly branched polymers via high throughput screens (HTS) and continuous processes, and compositions synthesized using the same.

### 2. Description of the Related Art

This application references a number of different references as indicated throughout the specification by one or more reference numbers. A list of these different references ordered according to these reference numbers can be found below in the section entitled “References.” Each of these is incorporated by reference herein.)

Highly branched polymers represent an appealing polymer architectures due to their unique properties. In comparison to their linear counterparts, highly branched polymers exhibit increased solubility, reduced viscosity, and an abundance of chain-end functional groups for post-polymerization reactivity. Currently, most methods for constructing highly branched architectures require the pre-synthesis of multifunctional monomers. However, in many instances, the monomer conversion needs to be carefully controlled to prevent network formation or gelation at high polymer concentrations.

The Strathclyde method enables the generation of highly branched soluble polymers through conventional radical polymerization. This method utilizes commercially available (meth)acrylate monomers and bis(meth)acrylate branching agents. Simple addition of defined amounts of thiol chain-transfer agents (CTAs) can significantly suppress the gelation even at nearly quantitative monomer conversions, allowing the production of soluble and low-viscosity branched polymers. The universality of this method is demonstrated its compatibility with various monomers and its synergy with other synthesis techniques such as emulsion/suspension polymerization, anionic polymerization, and flow chemistry. Notably, the properties of the resulting branched polymers, including molecular weight (M_{W}), dispersity (Ð), and degree of branching, are significantly related to reaction conditions, and are primarily affected by fine tuning of the feed ratio between monomer, branching agent, and CTA.

Consequently, an extensive screening of different variables is necessary to develop a new polymerization system for successful branched polymer synthesis. Given the multiple factors involved in the polymerization, high throughput screening (HTS) techniques emerge as invaluable tools for rapidly optimizing conditions and ensuring successful production of highly branched polymers without the formation of insoluble networks. Originally employed in the pharmaceutical industry, HTS techniques have found recent application in polymer chemistry, accelerating the development of new materials and the optimization of polymerization conditions.

### SUMMARY OF THE INVENTION

The present invention discloses the development of efficient condition optimization for the synthesis of highly branched polymers using high throughput screening. This innovation allows rapid production of soluble, highly branched polymers with different properties (molecular weight, degree of branching, etc.). Moreover, this versatile technique has the potential to be extended to other monomer/linker systems and polymerization techniques such as emulsion or suspension polymerization, anionic polymerization and continuous flow synthesis.

The present invention further discloses a resin composition, comprising 70.0 mol % or more of monofunctional (meth)acrylic acid alkyl esters (e.g., having alkyl, alkynyl or aryl groups and comprising one or more carbon atoms); 20.0 mol % or less of multifunctional (meth)acrylic acid alkyl esters (e.g., having alkylene, alkynylene or arylene groups and comprising 18 carbon atoms or less), and 0 or 0.01 mol % to 5 mol % or 10 mol % of (meth)acrylic acid, wherein a glass transition temperature of said resin composition is from −80° C. to 80° C., the resin composition is characterized by uniform dissolution of said resin composition in an organic solvent to form a solution comprising 1% to 80% by weight of the resin composition, and the solution exhibits flowability.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Referring now to the drawings in which like reference numbers represent corresponding parts throughout:

FIGS. 1A-1D. (A) Chemspeed automated synthesis platform using a reaction matrix for high throughput screening, and schematic of the reaction matrix comprising an array of cells (e.g., vials) each containing a unique combination of reactants. (B) Summarized variables, including feed ratio, concentration, RAFT CTA, time, and branching agents, studied in the high throughput screening.

FIGS. 2A-2F. Results of initial high throughput screening experiments via Chemspeed automated synthesis. (A) weight-average molecular weight (M_{W}) and dispersity (Ð) obtained from Gel Permeation Chromatography (GPC). (B) Conversions of nBA and EGDA C═C bond obtained from ¹H NMR. (C-E) GPC traces at different nBA and EGDA concentrations and varied feed ratios. (F). Example synthesis scheme of a reaction used in the screening.

FIGS. 3A-3F. Results of high throughput screening experiments at 4 M concentration. (A) Weight-average molecular weight (M_{W}) and dispersity (Ð) obtained from GPC. (B) Conversions of nBA and EGDA C═C bond obtained from ¹H NMR. (C-E) GPC traces with varied feed ratios of nBA, EGDA and CTA. (F) Example synthesis scheme of a reaction used in the screening.

FIGS. 4A-F. Results of high throughput screening experiments at 3 M concentration. (A) Weight-average molecular weight (M_{W}) and dispersity (Ð) obtained from GPC. (B) Conversions of nBA and EGDA C═C bond obtained from ¹H NMR. (C-E) GPC traces with varied feed ratios of nBA, EGDA and CTA. (F) Example synthesis scheme of a reaction used in the screening.

FIGS. 5A-51. Reproducibility tests at varied feed ratios and concentrations. (A-D) Comparison of weight-average molecular weight (M_{W}), dispersity (Ð), and conversions of nBA and EGDA C═C bond between the initial reaction and two repeated reactions. (E-H) GPC traces at varied conditions. (I) Example synthesis scheme of a reaction used in the screening.

FIGS. 6A-F. Results of high throughput screening experiments using RAFT CTA. (A) Weight-average molecular weight (M_{W}) and dispersity (Ð) obtained from GPC. (B) Conversions of nBA and EGDA C═C bond obtained from ¹H NMR. (C-E) GPC traces with varied feed ratios of nBA, EGDA and RAFT CTA. (F) Example synthesis scheme of a reaction used in the screening.

FIGS. 7A-7F. Results of high throughput screening experiments using AEMA. (A) Weight-average molecular weight (M_{W}) and dispersity (Ð) obtained from GPC. (B) Conversions of nBA and AEMA C═C bond obtained from ¹H NMR. (C-E) GPC traces with varied feed ratios of nBA, AEMA and CTA. (F) Example synthesis scheme of a reaction used in the screening.

FIGS. 8A-H. Results of high throughput screening experiments using EGDMA. (A) Weight-average molecular weight (M_{W}) and dispersity (Ð). (B) Conversions of nBA and AEMA C═C bond. (C-G) GPC traces with varied feed ratios of nBA, EGDMA and CTA. (H) Example synthesis scheme of a reaction used in the screening.

FIGS. 9A-D. Results of high throughput screening experiments on reaction time using EGDMA at varied feed ratios. The tables display the comparison of weight-average molecular weight (M_{W}), dispersity (Ð), and conversions of nBA and EGDMA C═C bond at different time points.

FIGS. 10A-10G. GPC traces of experiments in FIG. 9.

FIG. 10H Example synthesis scheme of a reaction used in the screening to obtain the data in FIGS. 9 and 10.

FIGS. 11A-C. Results of polymerization with nBA:EGDMA:thiol=97:3:2 from the Chemspeed synthesis platform and batch reactions. (A) GPC results, (B) weight-average molecular weight (M_{W}), dispersity (Ð), and conversions of nBA and EGDMA C═C bond; and (C) Example Synthesis Scheme of a reaction used in the screening.

FIGS. 12A-D. Thermal flow synthesis of highly branched polymer. (A) Schematic diagram of the flow synthesis set-up, and successful formation of plug flow. (B-D) Results of thermal flow synthesis and batch synthesis for reference, showing (B) weight-average molecular weight (M_{W}), dispersity (Ð), and conversions of nBA and EGDMA C═C bond and (C) GPC traces; and (D) Example Synthesis Scheme of a reaction used in the screening.

FIG. 13. General scheme and example method of synthesizing a branched polymer, comprising a plurality of non-crosslinked side chains, from a linear polymer. Synthesis conditions can be optimized for high conversion (˜99%) to pressure sensitive adhesive targets having low viscosity and high molecular weight (M_{w}>100,000).

FIG. 14. Prediction test of the solution/gel behavior of highly branched synthesis.

FIG. 15. Predictions of solution/gel boundaries at unexplored concentrations (3.5 M and 5 M).

FIGS. 16A-B. Validation of predicted solution/gel boundaries with experimental results at 3.5 M (A) and 5 M (B) concentrations.

FIG. 17. Absolute molecular weights of selected branched and linear polymers.

FIGS. 18A-E. Results of high-throughput synthesis of highly branched P(nBA-co-AA) (8 mmol scale). (A) Weight-average molecular weight (M_{w}^{SEC}) and dispersity (Ð^{SEC}) obtained using the illustrated example synthesis scheme. (B-E) SEC traces with varied feed ratios of nBA, EGDMA, AA and CTA using the example synthesis scheme shown in (A).

FIGS. 19A-D. SEC results of fractional precipitation for b-P1_{AA} (A) and b-P2_{AA} (B), wherein the tables (C, D) show weight-average molecular weight (M_{W}) and dispersity (Ð) for the pristine samples, as precipitate, and in solution.

FIGS. 20A-E. Scale-up synthesis of highly branched P(nBA-co-AA) (20 mmol scale); (A) synthesis scheme, SEC results, Mw and dispersity of the pristine and the fractionally precipitated b-P3_{AA} (B,D) and b-P4_{AA} samples (C,E) are displayed.

FIGS. 21A-B. Synthesis (A) of a linear P(nBA-co-AA) sample and its SEC trace (B).

FIGS. 22A-B. Flow sweep tests showing viscosity-shear rate correlation (A) of selected PnBA samples and corresponding viscosity values (B).

FIGS. 23A-B. Flow sweep tests showing viscosity-shear rate correlation (A) of selected P(nBA-co-AA) samples and corresponding viscosity values (B).

FIGS. 24A-B. (A) Schematic representation of 180° peel tests. (B) Results of 180° peel tests for selected PnBA samples (no signal obtained for b-P2).

FIGS. 25A-B. Results of 180° peel tests for selected P(nBA-co-AA) samples with 0.5 wt % Al(acac)₃ as physical crosslinker, for pristine (A) and fractionally precipitated (B) samples.

FIGS. 26A-C. Photos of representative peel tests for linear and branched P(nBA-co-AA) samples, showing partially adhesive failure for l-P1_{AA} (A) and fractionally precipitated (B) sample of b-P1_{AA}, and cohesive failure (C) of fractionally precipitated sample b-P2_{AA}.

FIG. 27. Example computer system.

FIG. 28. Example network system.

FIG. 29. Example synthesis method.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

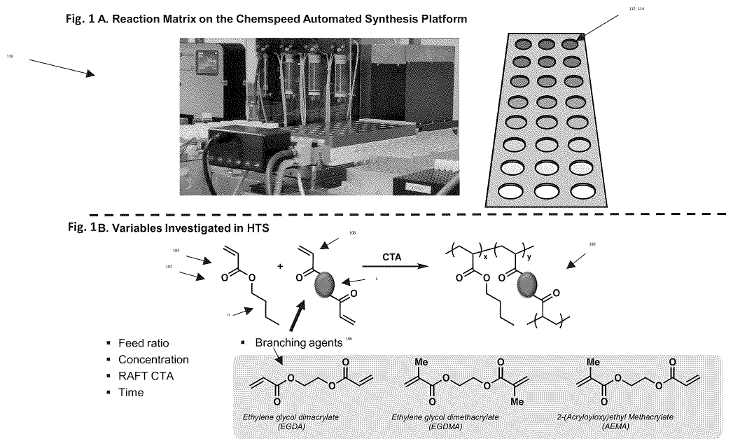

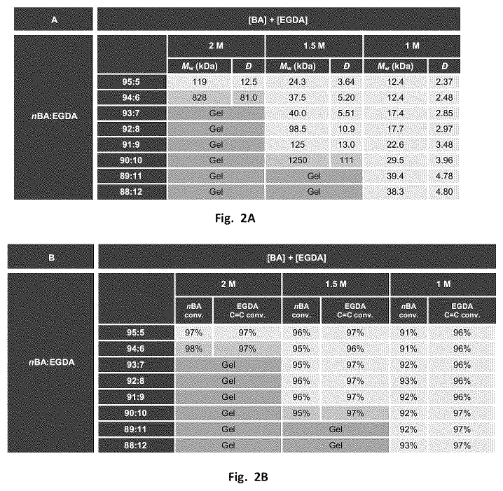

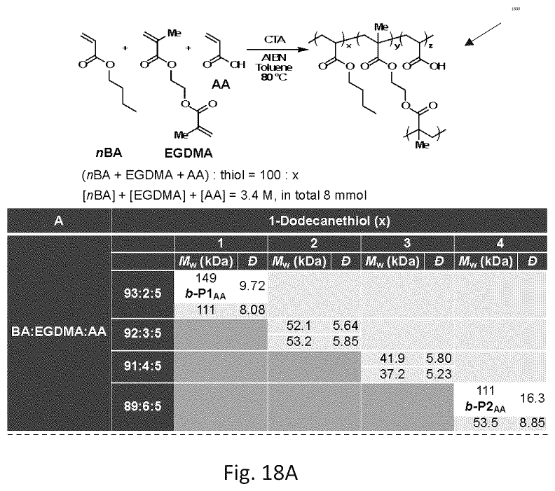

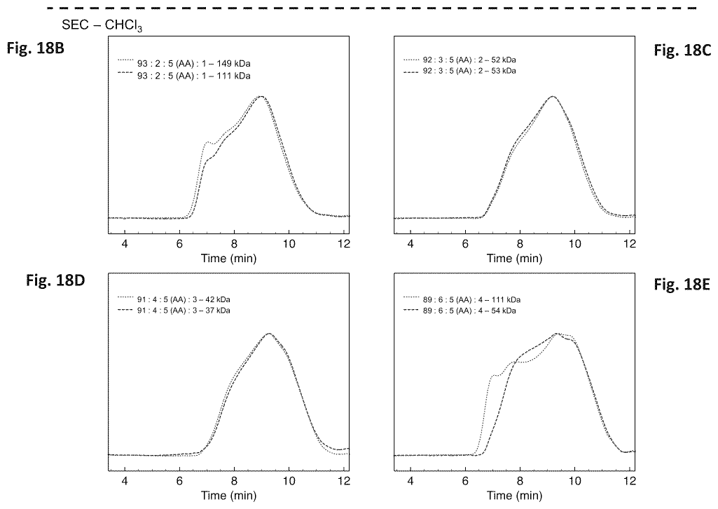

The present disclosure describes methods for synthesizing resin compositions, e.g., that can be used in various applications, including but not limited to. as adhesives (e.g., pressure adhesives). FIGS. 1 and 18 illustrate example resin compositions 100, 1800 include 70.0 mol % or more of a monomer 102 comprising an acrylic group 104 (e.g., methacrylic group) which may be attached to various carbon containing compounds R or varying size or length or composition; 20.0 mol % or less of a branching agent 106 comprising two or more acrylic groups 108 (e.g., methacrylic groups) connected by a linker L of varying size or length or composition (e.g., to form a compound comprising diacrylic groups, triacrylic groups, or tetracyclic groups connected by linker(s)), and 0 or 0.01 mol % to 5 mol % or 10 mol % of an acrylic acid AA (e.g., (meth)acrylic acid).

The compositions, concentrations, and reaction conditions can be selected to control formation of the resin composition as a branched polymer that is soluble rather than a gel. These variables can be determined using various methods (e.g., high throughput screening HTS) as described herein.

As used throughout this disclosure, (meth)acrylate is defined to comprise methacrylate or acrylate.

### 1. Chemspeed Automated Synthesis Platform and Variables Investigated in HTS

The Chemspeed™ robotic polymer synthesis platform within the BioPACIFIC MIP (BioPolymers, Automated Cellular Infrastructure, Flow, and Integrated Chemistry Materials Innovation Platform) 14, 15 (photo in 15 shows the whole system) provided by the NSF (National Science Foundation) enables HTS for optimizing reaction conditions in the synthesis of highly branched, multi-functional polymers (FIG. 1A).

In this platform 110 illustrated in FIG. 1A, multiple parallel reactors 112 perform thermal polymerization reactions in 48×8 mL disposable glass vials 114. Agitation for all reactors is accomplished by shaking. Robotic tools mounted to a motorized arm can perform a series of tasks, including screw-capping, the transfer of viscous and non-viscous liquids, the dispense of solids, and the transport of vials and vial racks. Thus, the Robotic Polymer Synthesis Platform integrating robotic handling with the automated powder and liquid handler/dispenser and high-throughput characterization enables the characterization of monomers, polymers, and material properties on the same timescale with which they can be made, overcoming traditional challenges to high-throughput materials discovery.

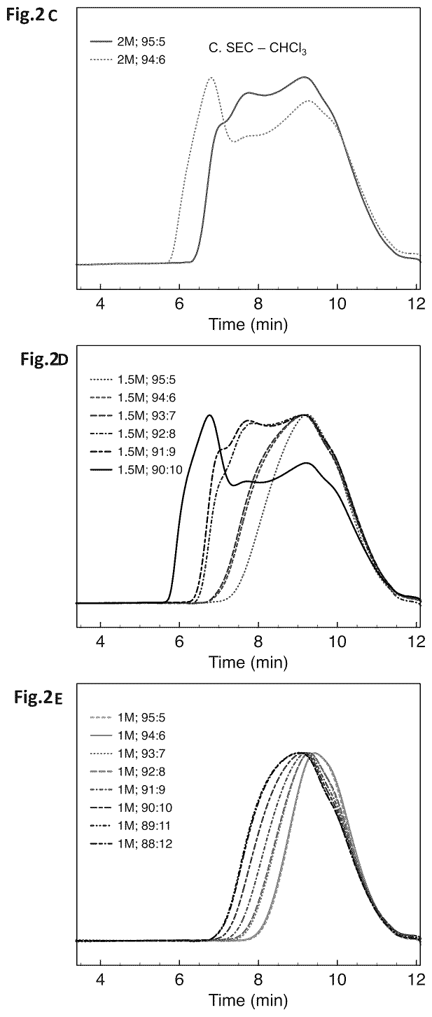

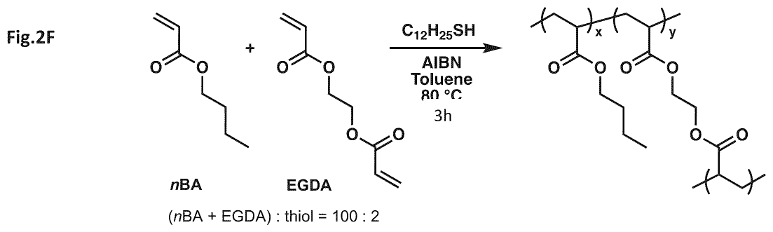

Due to the interest in pressure sensitive adhesives, this study focused on butyl acrylate as the primary monomer, with ethylene glycol diacrylate (EGDA) as the main branching agent. However, these strategies are expected to be adaptable to other readily available vinyl monomers. A range of variables were systematically investigated via parallel reactions conducted using the Chemspeed synthesis platform (FIG. 2A). The influence of key reaction conditions including the feed ratio and concentration was first studied. In addition to EGDA, two other difunctional linkers, ethylene glycol dimethacrylate (EGDMA) and 2-(acryloyloxy)ethyl methacrylate (AEMA) were compared at various feed ratios through HTS. Furthermore, the integration of the Strathclyde method and controlled radical polymerization procedures, such as reversible addition-fragmentation chain-transfer (RAFT) polymerization, was investigated by replacing the 1-dodecanethiol CTA with a RAFT agent. Finally, the effect of reaction time was also studied. The HTS results were evaluated by determination of gelation thresholds, along with standard characterization of polymers produced, including GPC (Gel Permeation Chromatography) and NMR (Nuclear Magnetic Resonance) spectroscopy.

### 2. HTS Experiments on the Chemspeed Automated Synthesis Platform

The high throughput screening experiment including 24 reactions focused on free radical polymerization of nBA and EGDA with 1-dodecanethiol CTA. The total concentration of nBA and EGDA and the feed ratio of nBA/EGDA as two major variables were investigated at a constant CTA loading of 2 mol %. The reactions that produced soluble polymers after 3 hours were characterized by ¹H NMR and GPC to determine the monomer conversions and molecular weights, respectively. Clear trends of gelation and molecular weight changes were observed relevant to these two variables (FIG. 2). At each nBA and EGDA concentration tested, increasing EGDA/CTA ratios produced polymers with higher weight-average molecular weights (M_{W}), dispersities (Ð), and viscosity, eventually leading to gelation (FIGS. 2A and 2C-2E). On the other hand, as the nBA and EGDA concentration increases, gelation is more likely to occur, and lower EGDA/CTA ratios are required to prevent gelation. In addition, over 90% conversions for both nBA and EGDA were observed for all reactions, indicating the successful production of highly branched polymers even at nearly full monomer conversions (FIG. 2B).

### 3. Additional Screening at Higher Concentrations

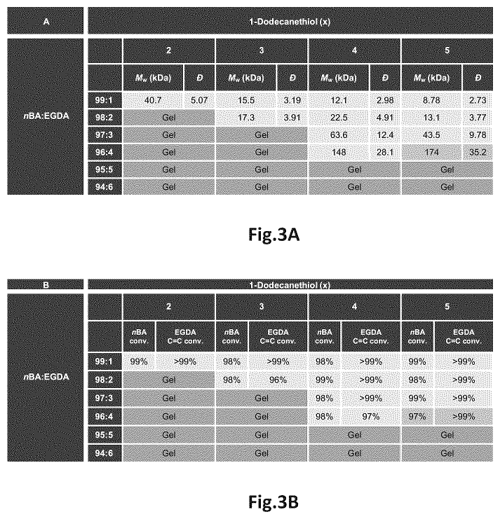

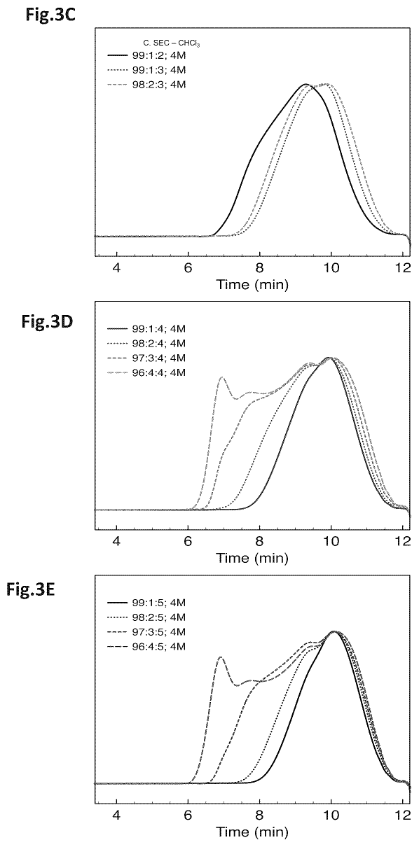

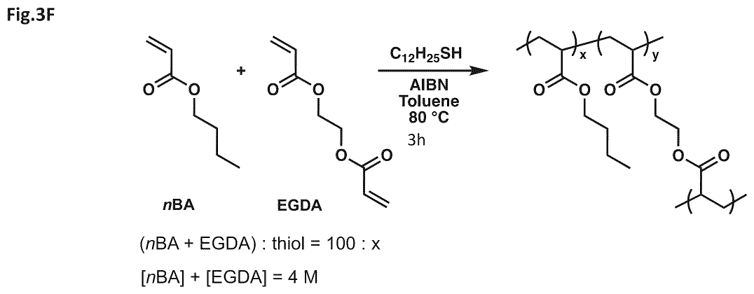

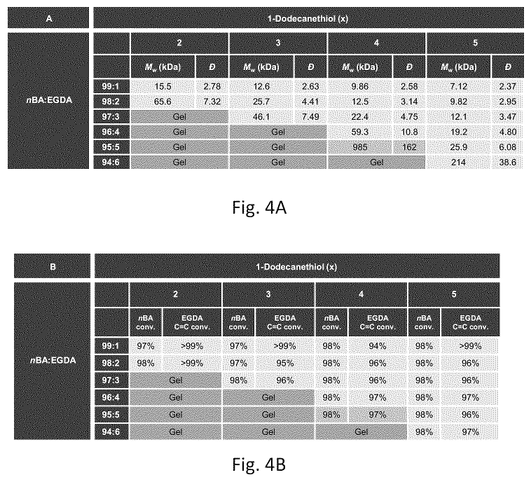

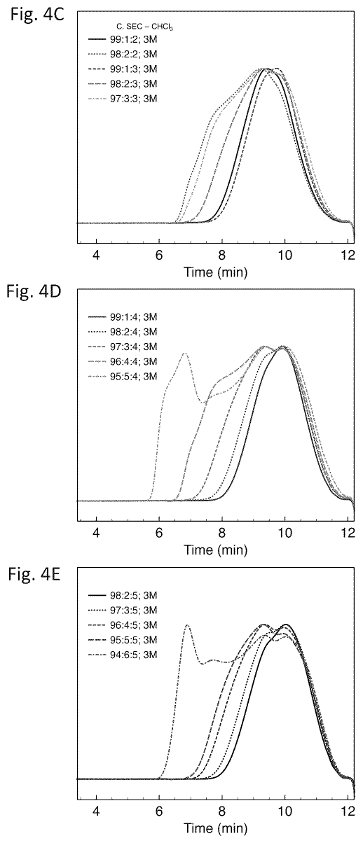

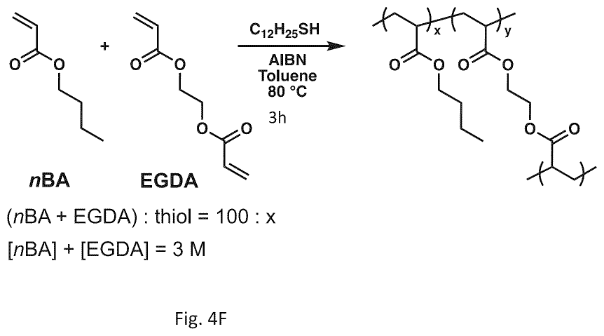

After the initial HTS experiment, different amounts of 1-dodecanethiol CTA at higher total concentrations of nBA and EGDA (4 M or 3 M) were tested (FIGS. 3 and 4). Similar to previous results, clear trends of gelation and molecular weight changes were again observed (FIGS. 3A and 4A). When the same amount of CTA was used, increasing nBA/EGDA ratios produced polymers with higher weight-average molecular weights (M_{W}) and viscosity, eventually leading to gelation. In contrast, at a fixed nBA:EGDA feed ratio, higher amounts of CTA led to lower M_{W} values and thus gelation is minimized. Furthermore, based on these results, the impact of concentration can be compared between the reactions at 4 M and 3 M. In general, at the same feed ratio of nBA:EGDA:CTA, the reaction at 4 M showed higher M_{W} values but also higher tendency for gelation.

### 4. Reproducibility Tests

Based on the aforementioned results, it was observed that the gelation threshold of the Strathclyde method is notably sensitive to the applied feed ratios of nBA, EGDA and CTA. A mere 1 mol % variation in the feed ratio of the EGDA linker or the thiol CTA could change the polymerization result from a solution to gelation. Therefore, ensuring the reproducibility of reactions on the Chemspeed synthesis platform is crucial and fundamental for obtaining reliable HTS results.

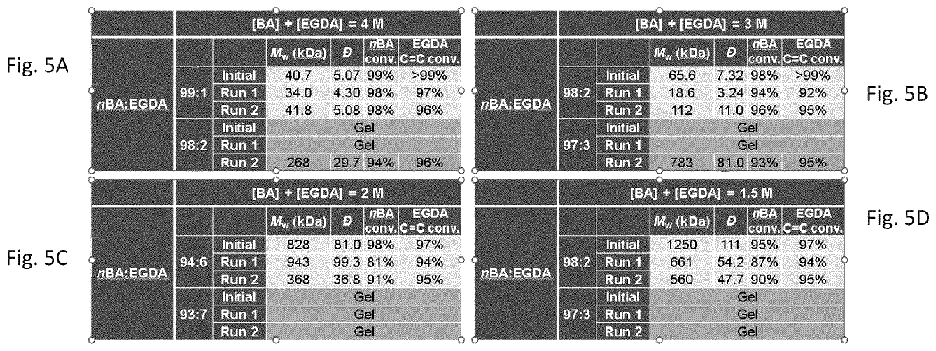

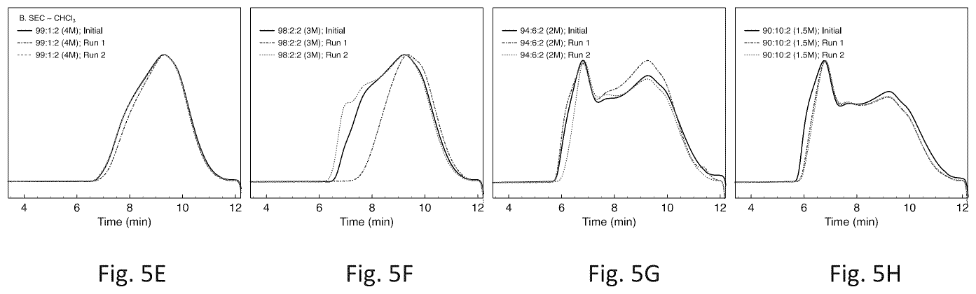

For the reproducibility tests, eight combinations of varied feed ratios and concentrations that led to results lying on the gelation boundary were selected from previous results. For each selected condition, two repeated reactions were conducted, maintaining identical feed ratios and concentrations. In most cases, consistent outcomes were achieved, including the gelation threshold, monomer conversions and GPC traces, underscoring the reliability of HTS via the Chemspeed automated synthesis (FIGS. 5A, 5B, 5C and 5D). Any inconsistency observed in few reactions could likely be attributed to the ±1% error associated with the Chemspeed syringe during the dispensing of liquid reagents. Overall, the reproducible results reinforce the advantages of utilizing Chemspeed high throughput screening in preparing highly branched polymers.

### 5. Tests on RAFT Agent

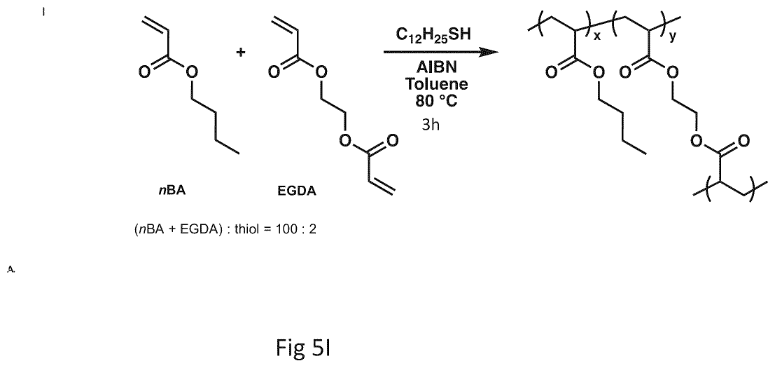

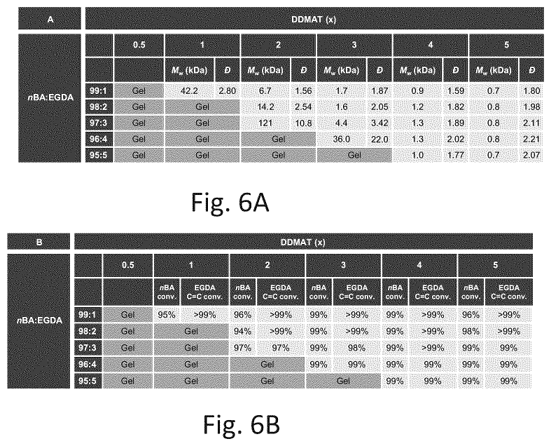

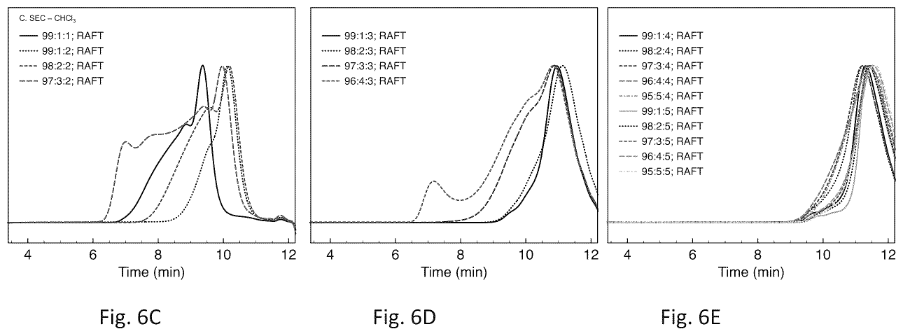

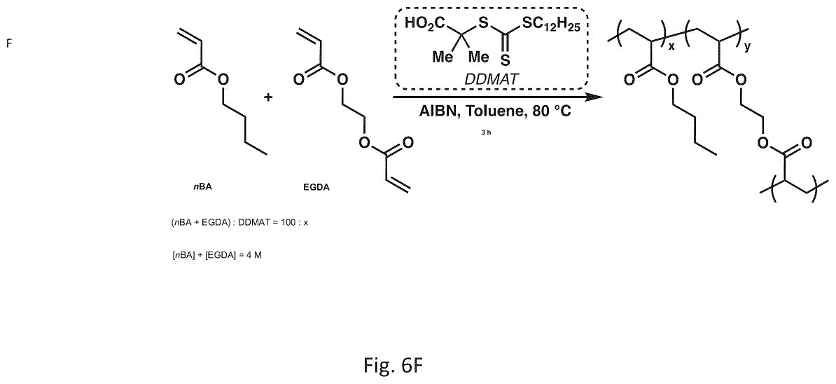

In addition to thiol CTAs, RAFT CTAs have also demonstrated successful application in the Strathclyde method. Here, 2-(dodecylthiocarbonothioylthio)-2-methylpropionic acid (DDMAT), as a trithiocarbonate CTA commonly used in RAFT polymerization of acrylates, was tested through HTS (FIG. 6). Unlike prior findings, the replacement of 1-dodecanethiol with DDMAT produced only oligomers when over 2 mol % of the RAFT agent was loaded. This result is likely attributed to the higher chain-transfer efficiency of DDMAT, leading to relatively shorter polymer chains. However, when 1 or 2 mol % of DDMAT was used, GPC traces revealed peaks with higher molecular weights alongside the oligomer peaks.

### 6. Tests on Different Divinyl Linkers

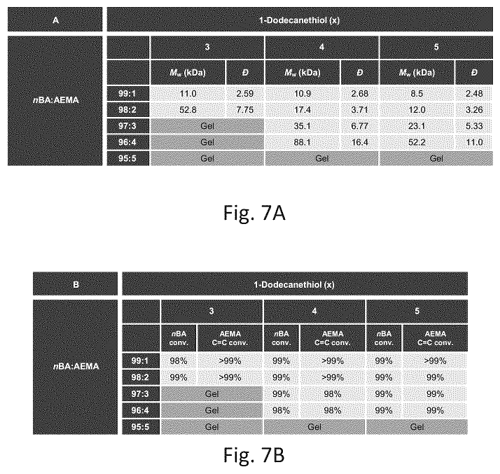

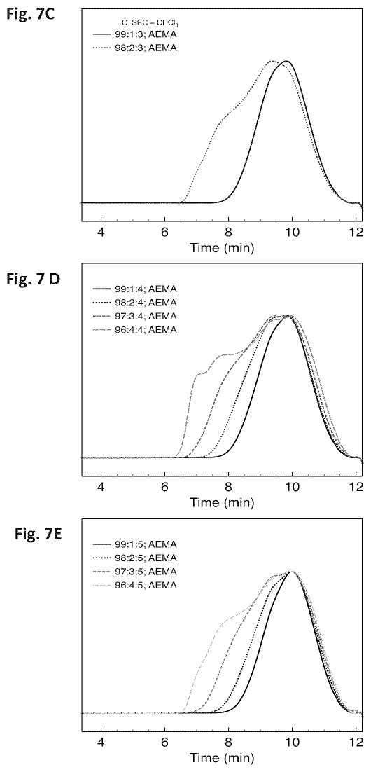

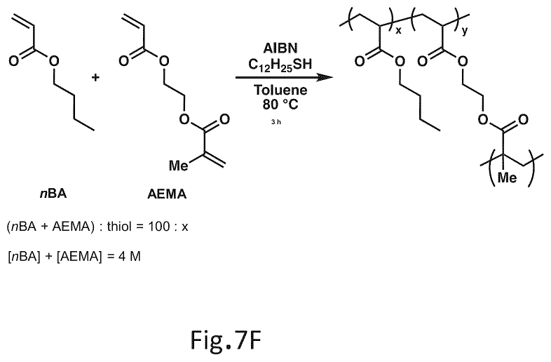

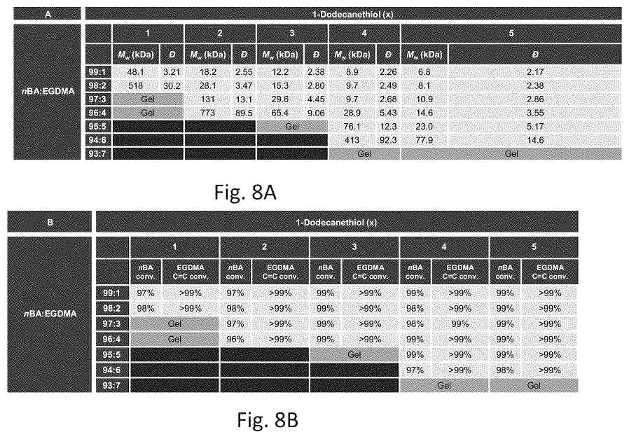

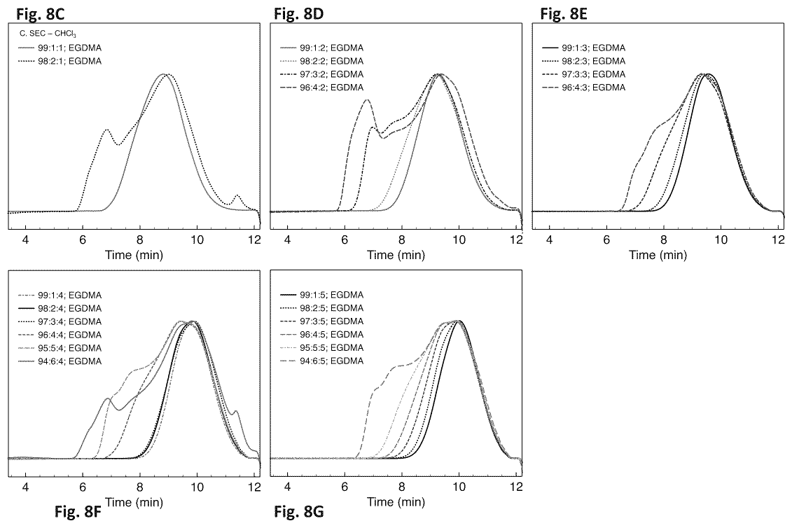

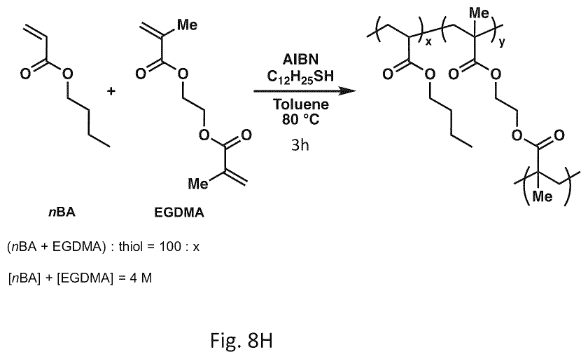

Building upon studies on the impact of thiol CTA quantity and monomer concentration, we then explored the influence of crosslinker structure at a concentration of 4 M. Alongside EGDA, two alternative linkers, the asymmetric crosslinker 2-(acryloyloxy)ethyl methacrylate (AEMA) and ethylene glycol dimethacrylate (EGDMA), were tested through HTS. The results are presented in FIGS. 7 and 8. By comparing the results at a defined feed ratio, a general trend of M_{W} for the three linkers is observed as EGDA>AEMA>EGDMA. In addition, while EGDA and AEMA exhibited similar gelation ranges, a relatively reduced level of gelation was observed in the case of EGDMA. These trends of gelation and molecular weight changes align with both prior batch experiments and the expected reactivity ratios for the acrylate and methacrylate copolymerization system. Specifically, a higher consumption of methacrylate than acrylate at the early stage of polymerization resulted in lower M_{W} and a delayed onset of gelation.

### 7. Screening on Reaction Time

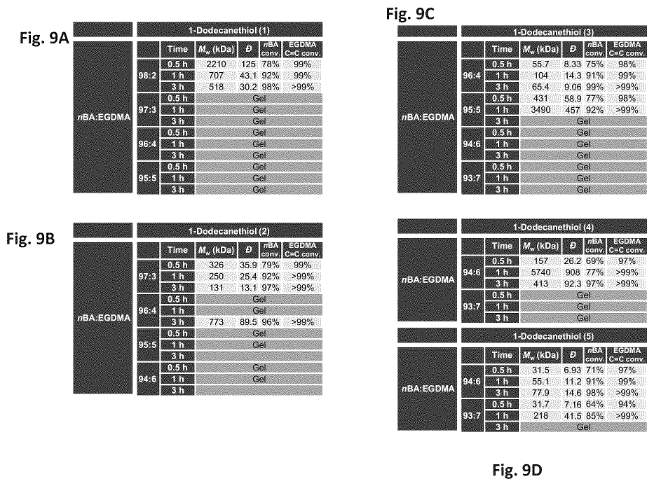

Moreover, the polymerization progress involving nBA, EGDMA and 1-dodecanethiol was monitored using the Chemspeed automated synthesis platform. Reactions with diverse feed ratios were halted at 0.5 or 1 hour, and the results were compared with prior data collected after 3 hours (FIG. 9). The gelation boundary emerged after 0.5 hours of the reaction due to the fast polymerization, and minimal changes on gelation were observed thereafter in most reactions. Rapid consumption of EGDMA led to almost full conversion within the initial 0.5 hours, while nBA reacted slower but substantial conversion, reaching over 90% after 3 hours. This discrepancy in reactivity is again consistent with the expected reactivity ratios for the acrylate and methacrylate copolymerization system.

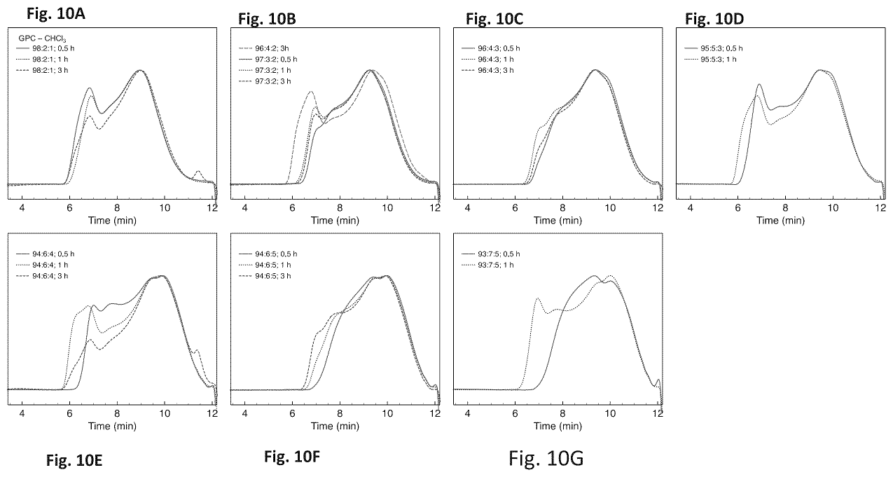

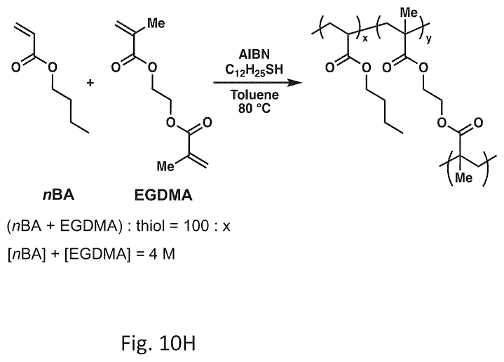

FIG. 10 shows GPC traces of experiments in FIG. 9.

8. Comparison with Batch Experiments

After the HTS was performed on the Chemspeed automated synthesis platform, selected

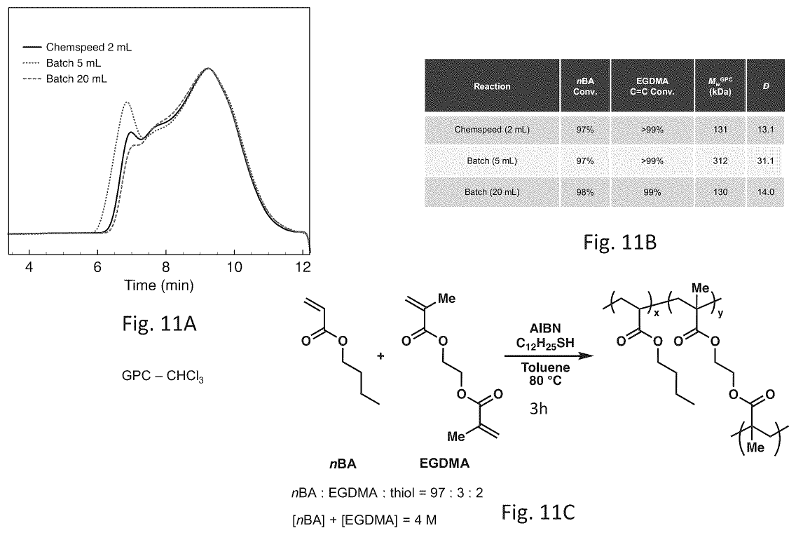

HTS results were further compared with outcomes from batch experiments. Specifically, the polymerization condition with a feed ratio of nBA:EGDMA:thiol=97:3:2 was selected for two batch reactions conducted at 5 mL and 20 mL scales. Good agreements were observed on GPC traces and monomer conversions (FIG. 11), reinforcing the reliability of the HTS technique.

### 9. Test on Flow Synthesis

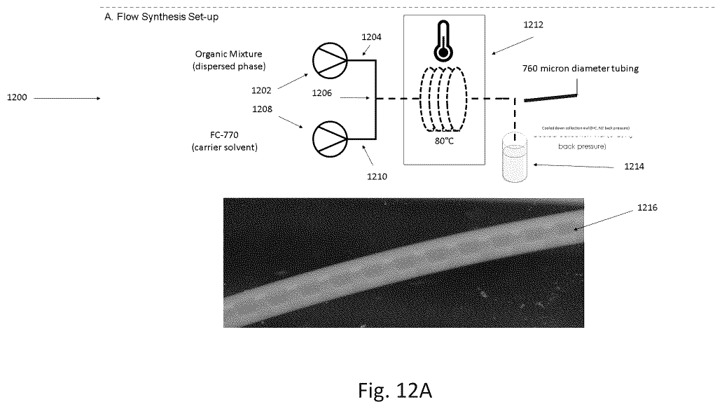

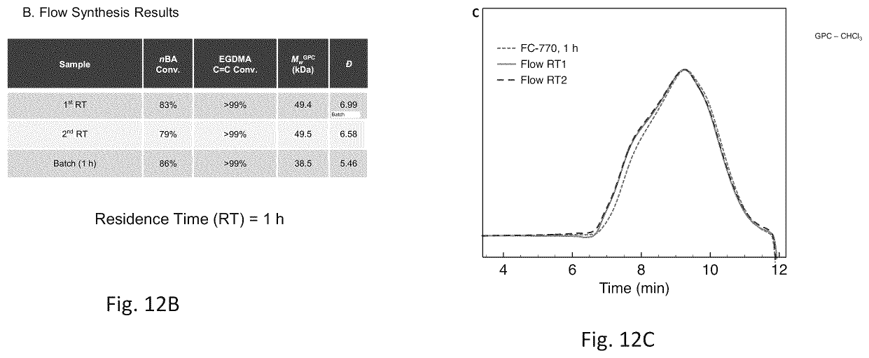

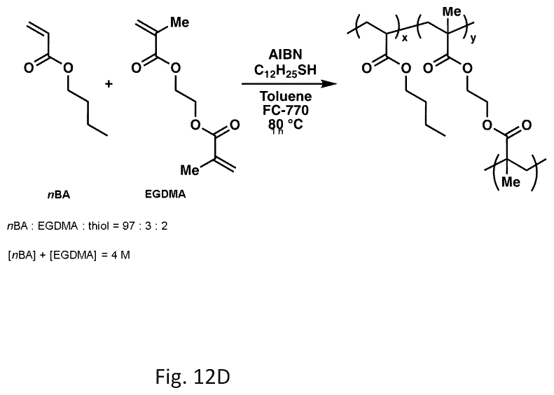

Finally, a test on the thermal flow synthesis of the branched polymer was conducted using BA, EGDMA and 1-dodecanethiol. Here, FC-770 was introduced as the fluorous spacer, facilitating the formation of a plug flow. (FIG. 12A). Setting the residence time at 1 hour led to successfully production of soluble polymers. Notably, no clogging issues of tubing or pumps were observed within the flow polymerization system, even at a monomer concentration of 4 M. The continuously produced branched polymer showed consistent molecular weights and dispersities (FIG. 12B). Similar conversions of EGDMA and BA were also observed throughout the flow synthesis. Moreover, the results of flow synthesis were found comparable with batch synthesis at the same reaction time with FC-770 as the additive. These findings suggest that the HTS results could be effectively applied in the continuous flow synthesis.

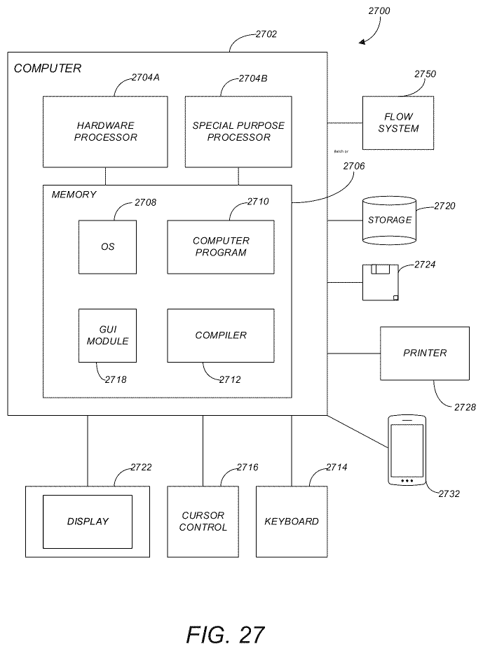

The plug flow synthesis uses a continuous flow system 1200 as illustrated in FIG. 12A [16], comprising a first pump 1202 for pumping the organic mixture (the dispersed phase comprised of monomer (nBA), branching agent (EGDMA), CTA (C₁₂H₂₅SH), initiator (AIBN), and solvent (toluene)) in a first tube 1204 to the mixer 1206; a second pump 1208 for pumping FC-770 (the carrier solvent, which can be any liquid not mixable with the dispersed phase. In some examples, various per-fluorinated liquid including FC-770 are preferred) in a second tube 1210 to the mixer 1206; so that a mixture of the organic mixture and the carrier solvent is distributed into a reactor coil 1212; a collection vial 1214 connected to the reactor coil; and a computer 2700 (illustrated in FIG. 27) programmable to control a flow rate and concentration of the reactants under continuous (e.g., plug flow 1216) conditions to form a polymer collected in the reaction vial.

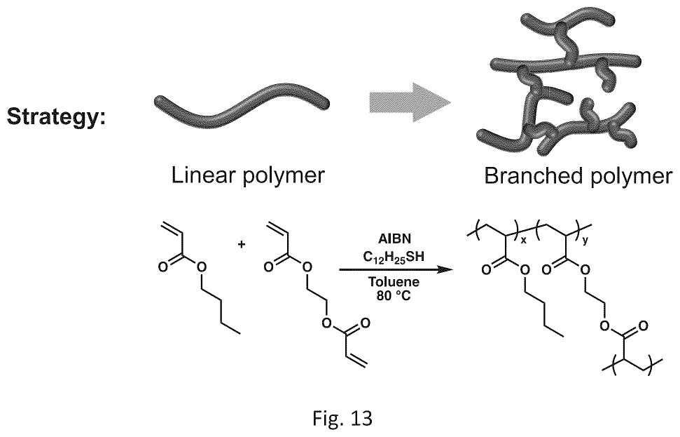

FIG. 13 illustrates the method of synthesizing the branched polymer using the methods described herein. In one embodiment, a linear polymer comprising monofunctional (meth)acrylic acid alkyl ester with relatively short chains is further crosslinked into the branched polymer using a linker such as a multifunctional (meth)acrylic acid alkyl ester. The resulting branched polymer can be used as a pressure sensitive adhesive (PSA) for example.

### 10. Prediction of Polymerization Solution-Gel Behavior Through Machine Learning

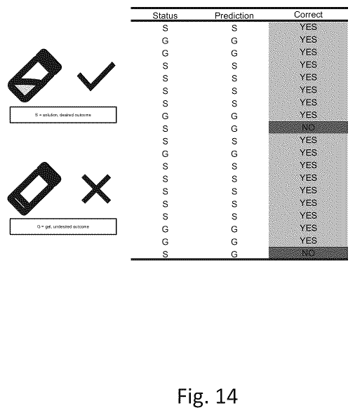

The high-throughput multi-dimensional data generated by the Chemspeed automated synthesis platform has enabled leverage of an off-the-shelf machine learning model, H2O-3 AutoML, to predict the behaviors of the highly branched synthesis. By training the model with a substantial portion of the high-throughput data, we were able to predict the solution/gel behavior of the polymerization through supervised learning. Approximately 90% accuracy was achieved in a prediction test across a range of polymerization conditions, including feed ratio and structures of the branching agent and CTA (FIG. 14).

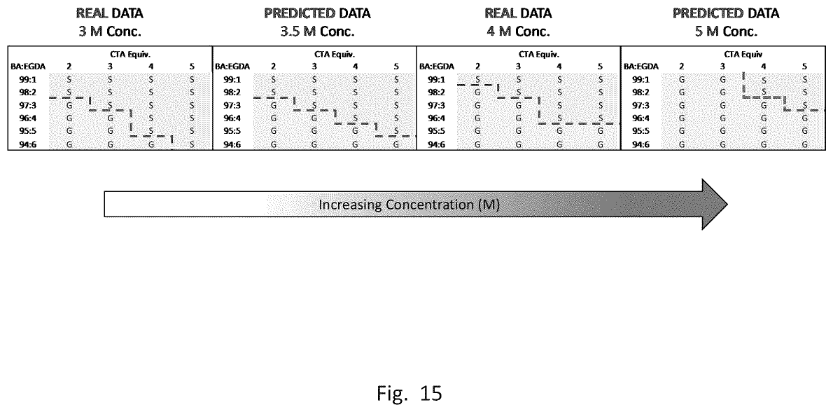

Furthermore, the machine learning model trained on existing data was utilized to predict gelation behavior in previously untested compositional spaces. Specifically, the solution/gel boundary related to feed ratio of nBA, EGDA and thiol CTA was predicted at a total concentration of BA and EGDA at 3.5 M, which had not been experimentally explored. This predicted boundary aligned with the expected behavior between experimentally obtained boundaries at 3 M and 4 M concentrations (FIG. 15). Additionally, solution/gel predictions at an even greater concentration (5 M) than those provided to the model yielded results consistent with existing expectations (FIG. 15). These initial successes suggest that the machine learning model may be viable for reasonably predicting gelation fronts in untested screening conditions.

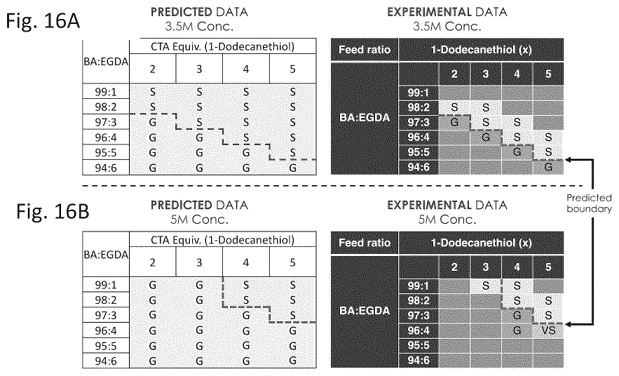

Finally, high-throughput synthesis experiments at 3.5 M and 5 M concentrations were conducted to validate the predicted solution/gel boundaries. Notably, only feed ratios near the predicted boundaries were selected for these reactions. At both concentrations, the experimental solution/gel boundaries showed good agreement with the predicted ones, showcasing the potential of machine learning in future screenings (FIG. 16).

### 11. Absolute Molecular Weights of Selected Branched Polymer Samples

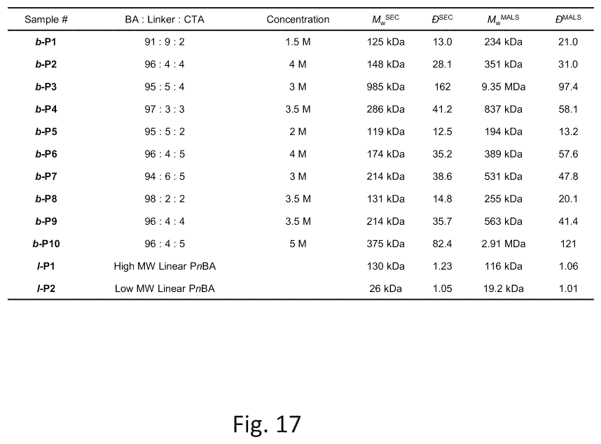

The molecular weights of highly branched poly(n-butyl acrylate) (PnBA) can be obtained from size exclusion chromatography (SEC) (also called gel permeation chromatography, GPC) by using linear polystyrene standards. While these relative weight-average molecular weights from SEC (M_{w}^{SEC}) exhibit clear trends as feed ratios or concentrations in the reaction conditions change, they are not accurate representations of the actual molar mass due to the different architectures between the branched samples and the linear polystyrene standards. Thus, absolute weight-average molecular weights of selected branched polymer samples with M_{w}^{SEC}>100 kDa were measured through multi-angle light scattering (MALS) detection. As shown in FIG. 17, the obtained absolute molecular weights (M_{w}^{MALS}) were higher than the corresponding M_{w}^{SEC} data, which is consistent with the branched nature of polymer samples.

Furthermore, two linear PnBA samples with high or low molecular weights were synthesized via controlled radical polymerization, and measured on SEC. Here, similar M_{w}^{MALS} and M_{w}^{SEC} values were obtained, as expected for linear PnBA samples.

12. Synthesis of Branched and Linear Poly(n-Butyl Acrylate) Incorporated with Acrylic Acid

### 12.1 High-Throughput Synthesis of Branched P(nBA-Co-AA) and Fractional Precipitation

PnBA incorporated with a small percentage of acrylic acid (AA) has been commonly used in pressure-sensitive adhesive (PSA) applications. To study the impact of branched architectures on adhesion properties, highly branched poly(n-butyl acrylate-co-acrylic acid) (P(nBA-co-AA)) copolymers were synthesized at 8 mmol scale using the Strathclyde method. Eight radical polymerization reactions containing nBA, AA, ethylene glycol dimethacrylate (EGDMA), and 1-dodecanethiol (DDT) CTA were successfully performed on the Chemspeed automated synthesis platform at four different feed ratios, with two identical reactions at each feed ratio. These feed ratios were selected based on previous high-throughput synthesis results including nBA, EGDMA, and DDT but without AA, to ensure the formation of soluble branched polymers with relatively high molecular weights. The SEC data showed consistent results for the two reactions conducted at each feed ratio. These branched P(nBA-co-AA) copolymers contain around 5 mol % of AA, with M_{w}^{SEC} ranging from 30 kDa to 150 kDa, and dispersity (Ð^{SEC}) ranging from 5 to 17 (FIG. 18).

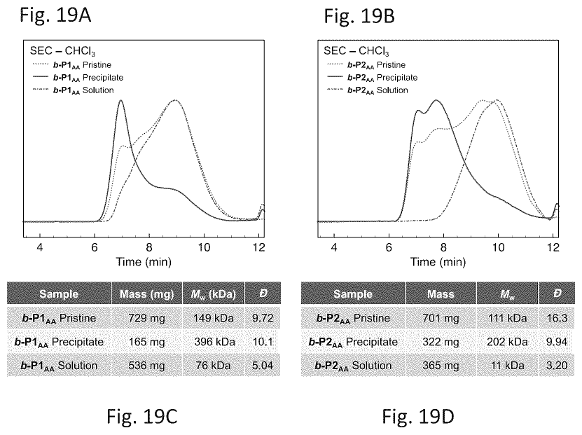

Next, two of these branched P(nBA-co-AA) copolymers with M_{w}^{SEC}>100 kDa (b-P1_{AA}, nBA:EGDMA:AA:DDT=93:2:5:1, M_{w}^{SEC}=149 kDa; b-P2_{AA}, nBA:EGDMA:AA:DDT=89:6:5:4, M_{w}^{SEC}=111 kDa) were subjected to the fractional precipitation conditions using a THF:MeOH mixture (1:10, v/v). This process enabled the precipitation of the high-molecular-weight fractions (b-P1_{AA}-FP, and b-P2_{AA}-FP), while the low-molecular-weight components remained dissolved in the supernatant, as shown by the SEC traces (FIG. 19).

### 12.2 Scale-Up Synthesis of Branched P(nBA-Co-AA) and Fractional Precipitation

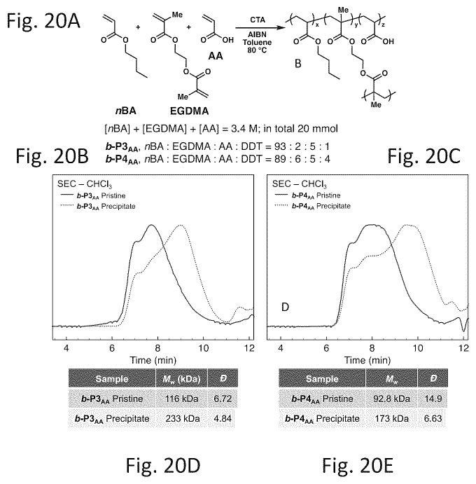

The synthesis of b-P1_{AA} and b-P2_{AA} was then repeated on a larger scale (20 mmol) for viscosity and adhesion measurements. The obtained b-P3_{AA} and b-P4_{AA} copolymers were again fractionally precipitated to remove the low-molecular-weight components and the high-molecular-weight fractions were collected (b-P3_{AA}-FP, and b-P4_{AA}-FP) (FIG. 20).

### 12.3 Synthesis of Linear P(nBA-co-AA) as a Control

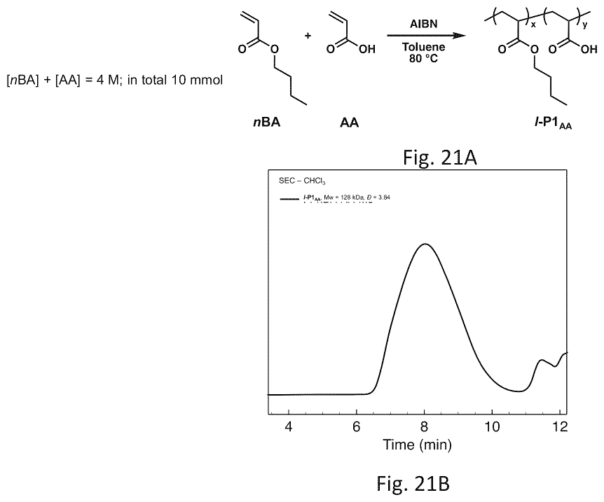

In addition to branched P(nBA-co-AA) copolymers, one linear P(nBA-co-AA) copolymer (l-P1_{AA}) was prepared through free radical copolymerization of nBA and AA as a control for viscosity and adhesion measurements (FIG. 21).

### 13. Viscosity Measurements of Selected Polymers on Rheometer

13.1 Viscosity Measurements of Selected PnBA Samples without Acrylic Acid

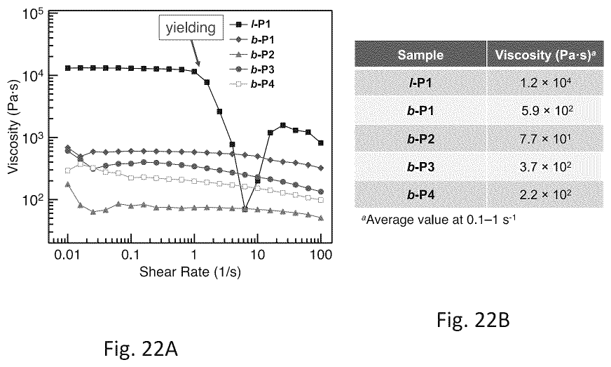

The viscosity of selected PnBA with no AA incorporation was measured on an ARES-G2 rheometer. Four highly branched PnBA samples with M_{w}^{SEC}>100 kDa (b-P1, b-P2, b-P3, and b-P4 in FIG. 17) were selected for viscosity measurements. In addition, a high-molecular-weight linear PnBA sample (l-P1) was also tested as a control. Flow sweep curves showing the viscosity-shear rate correlation for selected highly branched PnBA samples and the linear PnBA control sample are displayed in FIG. 22.

While the linear PnBA control (l-P1) exhibited yielding behavior at the shear rate above 1 s⁻¹, none of the branched PnBA samples showed yielding across the entire shear rate range tested. Additionally, the viscosity values of all branched PnBA samples at low shear rates were more than an order of magnitude lower than that of the linear PnBA control. Furthermore, the viscosity of branched PnBA remained unaffected by the variations in M_{w} values across these samples. These results of distinct viscosity behavior between branched and linear PnBA samples are likely attributed to the branching structure and the presence of low-molecular-weight components in the branched samples.

### 13.2 Viscosity Measurements of Selected P(nBA-Co-AA) Samples

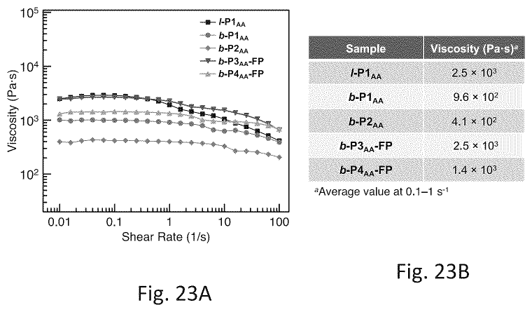

The viscosity of selected P(nBA-co-AA) copolymers was then measured on the rheometer, and the results are displayed in FIG. 23. The two highly branched P(nBA-co-AA) samples (b-P1_{AA} and b-P2_{AA}) showed viscosity at the same order of magnitude compared to branched PnBA samples without AA. Additionally, for the two highly branched P(nBA-co-AA) samples obtained from fractional precipitation (b-P3_{AA}-FP and b-P4_{AA}-FP), slightly higher viscosity was observed, likely due to the removal of low-molecular-weight components. Furthermore, in contrast to the linear PnBA control (l-P1) that was prepared from controlled radical polymerization with a low dispersity (Ð^{SEC}=1.23), the linear P(nBA-co-AA) control (l-P1_{AA}) prepared from free radical polymerization with a high molecular weight distribution (Ð^{SEC}=3.84) showed lower viscosity with no yielding behavior at the shear rate above 1 s⁻¹. This is likely due to the higher content of low-molecular-weight components in the l-P1_{AA} sample.

### 14. Adhesion Measurements Using 180° Peel Tests

14.1 180° Peel Tests of Selected PnBA Samples without Acrylic Acid

The adhesion properties of highly branched polymers were studied. The polymer sample was solvent-cast between a glass slide (75 mm×25 mm, length×width) and a polyethylene terephthalate (PET) film, and subjected to the 180° peel test on a texture analyzer (FIG. 24A). The average peel force (N/25 mm) was then calculated based on multiple parallel tests conducted on the same sample.

Peel forces of PnBA samples with no acrylic acid incorporation were measured via 180° peel tests. Highly branched PnBA (b-P1, b-P2, b-P3, b-P4) samples and the linear PnBA control (l-P1) were tested. The peel forces of all branched PnBA samples were at least five times lower than that of the linear PnBA control.

### 14.2 180° Peel Tests of Selected P(nBA-Co-AA) Samples

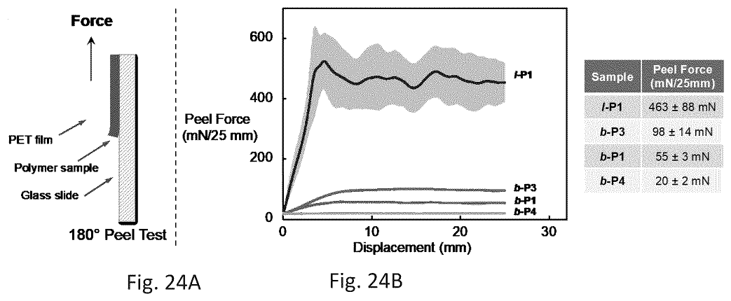

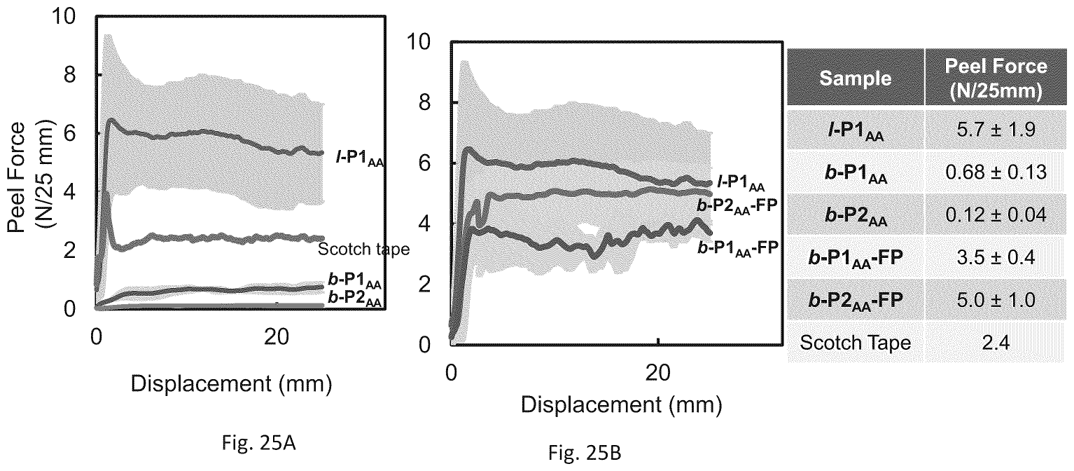

Peel forces of P(nBA-co-AA) samples were then measured via 180° peel tests. During the solvent-casting of the polymer samples, aluminum acetylacetonate (Al(acac)₃) (0.5 wt % relative to P(nBA-co-AA)) was added to physically crosslink the acrylic acid groups and enhance the adhesion performance. The pristine highly branched P(nBA-co-AA) samples (b-P1_{AA} and b-P2_{AA}), the fractionally precipitated highly branched P(nBA-co-AA) samples (b-P1_{AA}-FP and b-P2_{AA}-FP), as well as the linear P(nBA-co-AA) control (l-P1_{AA}) were tested, and the results were displayed in FIG. 25.

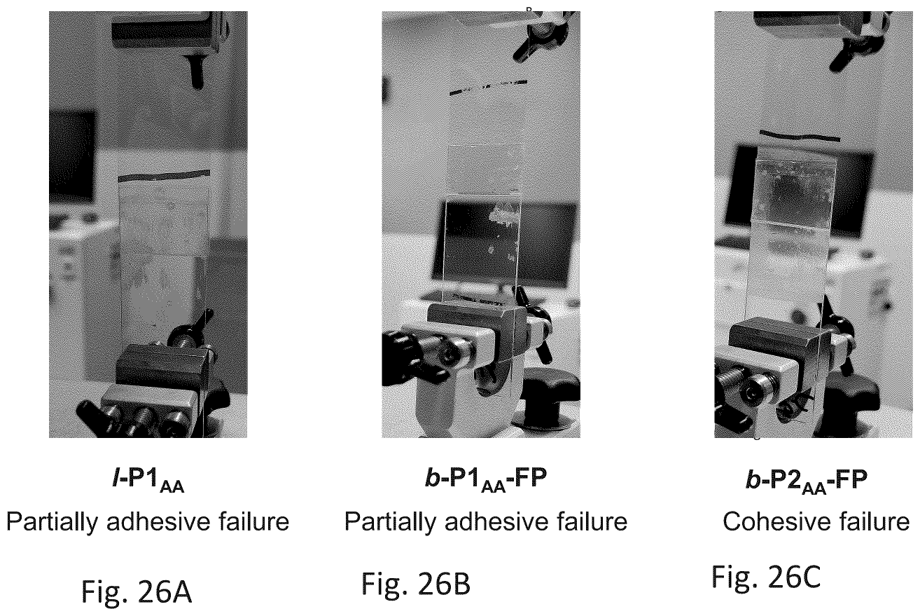

The physical crosslinking of AA via Al(acac)₃ significantly enhanced peel forces for both linear and branched P(nBA-co-AA) samples, compared to those of the corresponding PnBA samples with no AA incorporation. Additionally, while the two pristine branched P(nBA-co-AA) samples (b-P1_{AA} and b-P2_{AA}) exhibited lower peel forces than the linear P(nBA-co-AA) control (l-P1_{AA}), fractional precipitation of the branched P(nBA-co-AA) samples (b-P1_{AA}-FP and b-P2_{AA}-FP) resulted in a significant increase in peel forces. Notably, the observed peel forces for samples b-P1_{AA}-FP and b-P2_{AA}-FP were of the same order of magnitude as those of the linear P(nBA-co-AA) control (l-P1_{AA}). Furthermore, cohesive failure was observed during the peel tests of branched sample b-P2_{AA}-FP, whereas partial adhesive failure was noted for the branched sample b-P1_{AA}-FP and linear control l-P1_{AA} (FIG. 26).

### General Requirements for Resin Composition.

The chemical structure of the resin composition described in the present invention is represented by the following general formula (I). The resin composition consists of mono and multi-functional (meth)acrylic acid ester, and (meth)acrylic acid, which are defined in detail below.

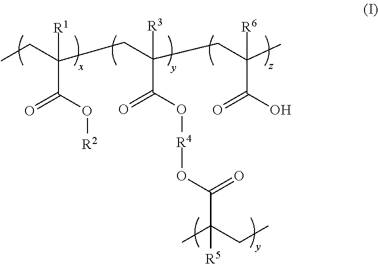

In the general formula (I), A resin composition comprising 70.0 mol % or 90.0 mol % to 99.9 mol % or more of monofunctional (meth)acrylic acid alkyl esters as x component, and 0.01 mol % to 10.0 mol % or 20 mol % or less of multifunctional (meth)acrylic acid alkyl esters as y component, and 0 or 0.01 mol % to 5 mol % or 10 mol % of (meth)acrylic acid as z component. And a glass transition temperature of said resin composition is from −80° C. to 80° C., and a resin composition characterized by uniform dissolution of said resin composition in an organic solvent in the range of 1% to 80% by weight, wherein the solution exhibits flowability (The displacement of the sample solution is not zero when 1 g of the sample solution is taken in a vial and the vial is placed upside down and allowed to stand for 1 hour.).

Mono-functional (meth)acrylic acid alkyl esters component of general formula (I), R¹ can be selected from a hydrogen atom or a methyl group. When R¹ is a hydrogen the glass transition temperature of the polymer can be lowered, which gives the resin composition more flexibility. When R¹ is a methyl group, on the contrary, the polymer can become more rigid. R² can be selected from linear or branched alkyl, alkenyl, and aryl groups having 1 to 18 carbon atoms. The higher the carbon number of R, the more flexibility can be given to the resin composition and these R¹ and R² can be selected as needed. Among these, in one or more examples n-butyl acrylate (nBA) is preferred because of its fast polymerization reaction rate and its ability to provide sufficient flexibility to the resin composition.

Multi-functional (meth)acrylic acid alkyl esters component of general formula (I), R³ and R⁵ can be selected from hydrogen atom and methyl group for the same reason of R¹. R⁴ can be selected from groups having 1 to 18 carbon atoms or having 1 to 6 (meth)acryloyl groups. The higher the carbon number, the further apart the polymer chains that make up the resin composition are, can result in better flowability in the solution state, but lower viscosity and therefore lower adhesive strength. The higher the number of (meth)acryloyl groups, the faster the polymerization progresses, and the adhesive strength increases as the viscosity increases. However, if the number of (meth)acryloyl groups exceeds 6, the fluidity may disappear due to excessive gelation. In one or more examples, ethylene glycol diacrylate, ethylene glycol dimethacrylate, 2-acryloyloxyethyl methacrylate, pentaerythritol triacrylate, pentaerythritol tetraacrylate, dipentaerythritol pentaacrylate and dipentaerythritol hexaacrylate are preferred. In some more examples, ethylene glycol diacrylate and ethylene glycol dimethacrylate are particularly preferred. The multi-functional (meth)acrylates can be replaced with other multifunctional vinyl compounds as needed. Examples of multifunctional vinyl compounds include divinylbenzene, trivinylbenzene, tetravinylbenzene, and divinyl ether.

(Meth)acrylic acid component of general formula (I), R⁶ can be selected from hydrogen atom and methyl group for the same reason of R¹, R³ and R⁵. In one or more examples, acrylic acid is preferred, as the polymerization proceeds efficiently.

### Polymerization Conditions

General radical polymerization conditions can be used for the resin composition described in this invention. Free radical polymerization using a chain transfer agent (CTA), reversible addition-fragmentation chain transfer (RAFT) polymerization, and atom transfer radical polymerization (ATRP) are preferred since the molecular weight can be easily adjusted. Solvents for polymerization are not limited, and hydrocarbons, alcohols, esters, ketones, nitriles and organic halides can be used. Among these solvents, in one or more examples, toluene, xylene, isopropanol, trifluoroethanol, hexafluoroisopropanol, ethyl acetate, butyl acetate, acetone, methyl ethyl ketone, cyclohexanone, acetonitrile, dichloromethane, chloroform, chlorobenzene, and bromobenzene are preferred due to their chemical stability and moderate volatility that can be used as the polymer solutions as is after polymerization. Among these solvents, in some more examples, toluene, xylene, methyl ethyl ketone, and butyl acetate are more preferred.

Regarding initiators, common radical initiators can be used. In one or more examples, azobisisobutyronitrile is preferred among them.

The reaction temperature can be selected according to the decomposition temperature of the initiator; however, a polymerization rate of 50° C. to 70° C. or higher is sufficient, and gelation can be suppressed by controlling the decomposition of excessive initiator.

### Metal Salts as an Additive

Metal salts can be added to solutions containing the resin compositions described in this invention. The metal salt forms a complex with carboxyl groups in the resin composition and improves the adhesive strength of the resin composition. The amount of metal salt added should be between 0.05% to 5% or 10% or less of the resin composition by weight. If too little is added, the adhesive strength is not improved, and if too much is added, the resin composition becomes brittle and the impact strength decreases. Available metal salts include calcium, magnesium, boron, zinc, aluminum, copper, iron, cobalt, nickel, and manganese salts. Among these, in one or more examples, magnesium, calcium, and aluminum salts are preferred because they form stable complexes with the resin composition. In some more examples, aluminum salts are more preferred. Specific example of aluminum salts includes aluminum acetylacetate complexes.

### Example Compositions and Methods

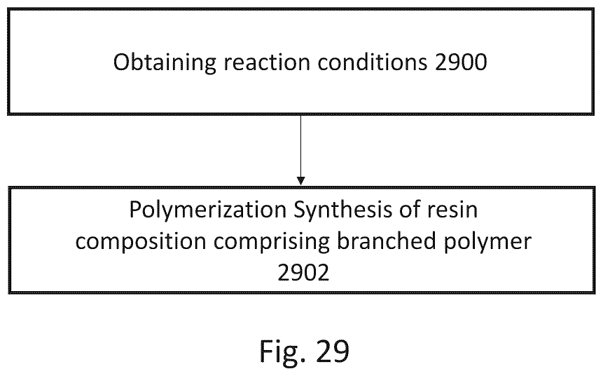

Illustrative compositions that can be fabricated using the methods described herein include, but are not limited to, the following (referring to FIGS. 1-29).

1. A resin composition comprising 70.0 mol % or 90.0 mol % to 99.9 mol % or more of monofunctional (meth)acrylic acid alkyl esters (e.g., comprising alkyl, alkynyl or aryl groups of 1 to 18 carbon atoms or more) and 0.01 mol % to 10.0 mol % or 20 mol % or less of multifunctional (meth)acrylic acid alkyl esters (e.g., comprising alkylene, alkynylene or arylene groups of 1 to 18 carbon atoms or less), and 0 or 0.01 mol % to 5 mol % or 10 mol % of (meth)acrylic acid and a glass transition temperature of said resin composition is from −80° C. to 80° C., and a resin composition characterized by uniform dissolution of said resin composition in an organic solvent in the range of 1% to 80% or 90% by weight, wherein the solution exhibits flowability (e.g., comprising a liquid not a gel, or characterized in that the resin composition is dissolved in the solvent to form the solution).

2. The resin composition of embodiment 1 wherein:
one or more of the monofunctional (meth)acrylic acid alkyl esters comprise alkyl, alkynyl or aryl groups, wherein the alkyl, alkynyl or aryl groups comprise one or more carbon atoms, and/or
one or more of the multifunctional (meth)acrylic acid alkyl esters comprise alkylene, alkynylene or arylene groups comprise 18 carbon atoms or less, or wherein the alkylene, alkynylene or arylene groups comprise 18 carbon atoms or less.

3. The resin composition of embodiment 1 or 2, wherein:
one or more of the monofunctional (meth)acrylic acid alkyl esters comprise (or the groups in the ester further comprise) one or more heteroatoms (e.g., oxygen, sulfur, silicon, nitrogen, phosphor and/or halogen atoms), e.g., so that the esters comprise ethylene oxide, siloxane, amine and/or amide units, and/or
one or more of the multifunctional (meth)acrylic acid alkyl esters comprise (or the groups in the esters further comprise) one or more heteroatoms (e.g., oxygen, sulfur, silicon, nitrogen, phosphor and/or halogen atoms), e.g., so that the esters comprise ethylene oxide, siloxane, amine and/or amide units.

In other embodiments, the monofunctional alkyl esters comprise just a hydrogen, e.g. methacrylic acid and acrylic acid.

4. The resin composition of any of the embodiments 1-4, comprising 99.9 mol % or more of the monofunctional (meth)acrylic acid alkyl esters.

5. The resin composition of embodiment 1 or 2 or 3 or 4, comprising 0.01 mol % or less of the multifunctional (meth)acrylic acid alkyl esters.

6. The resin composition of any of the embodiments 1-5, comprising a concentration of 80.0 mol %≤concentration ≤99.9 mol % of the monofunctional (meth)acrylic acid alkyl esters and/or a concentration of 0.01 mol %≤concentration ≤20.0 mol % of the multifunctional (meth)acrylic acid alkyl esters.

7. The resin composition of any of the embodiments 1-6, wherein one or more of the monofunctional (meth)acrylic acid alkyl esters comprise 1≤number of carbon atoms ≤18.

8. The resin composition of any of the embodiments 1-6, wherein one or more of the monofunctional (meth)acrylic acid alkyl esters comprise more than 18 carbon atoms.

9. The resin composition of any of the embodiments 1-8, wherein one or more the multifunctional (meth)acrylic acid alkyl esters comprise 1≤number of carbon atoms ≤18.

10. The resin composition of any of the claims 1-9, wherein the monofunctional and/or multifunctional (meth)acrylate acid alkyl esters comprise 2 or more carbons in the alkyl groups (e.g. the alkyl groups comprise ethyl, propyl, butyl, 2-ethylhexyl groups or larger; or comprise ethylene, propylene, butylene groups or larger).

11. The resin composition of any of the embodiments 1-10, wherein the multifunctional (meth)acrylate acid alkyl esters comprise asymmetric multifunctional (meth)acrylate acid alkyl esters.

12. The resin composition of any of the embodiments 1-11, wherein the dissolution of the resin composition in the organic solvent forms composition polymers having a molecular weight larger than 70 kDa.

13. The resin composition of any of the embodiments 1-12, wherein less than 50%, or less than 40%, or less than 30%, or less than 20%, or less than 10%, or less than 5% of the solvent by volume is used in the polymerization of the resin composition in the solvent.

14. The resin composition of any of the embodiments 1-13, further comprising 0.1 mol % to 10 mol % or 20 mol % of (meth)acrylic acid.

15. The resin composition according to any of the embodiments 1-14, wherein a weight average molecular weight Mw of the resin composition by Gel Permeation Chromatography (GPC) measurement as polystyrene equivalent is between 0.5 kDa and 1000.0 kDa, or between 10 kDa and 1000 kDa, or between 50 kDa and 1000 kDa (inclusive of endpoints); or wherein a weight average molecular weight Mw of the resin composition by Multi-angle Light Scattering (MALS) measurement is between 0.5 kDa and 10000 kDa, or between 10 kDa and 10000 kDa, or between 100 kDa and 10000 kDa (inclusive of endpoints); and the polydispersity (PDI) is between 1.00 and 120, or between 1 and 50, or between 1 and 20, or between 1 and 10 (inclusive of endpoints).

16. The resin composition according to any of the embodiments 1-15, wherein the multifunctional (meth)acrylic acid alkyl ester is either ethylene glycol di(meth)acrylate or 2-(acryloyloxy)ethyl methacrylate (AEMA). The multifunctional (meth)acrylic ester can have asymmetric structure, for example.

17. A method for manufacturing a resin composition according to any of embodiments 1 to 16, wherein the method for manufacturing the resin composition according to any of embodiments 1 to 16 is a continuous process (e.g., using a Strathclyde method in a continuous capillary reactor, continuous flow system/reactor, or plug flow reactor as illustrated in FIG. 12).

18. An adhesive comprising the resin composition according to any of the embodiments 1 to 16.

19. A method 2900 of screening reactants for a polymerization reaction, comprising:
performing a plurality of reactions in parallel between reactants comprising a first reactant comprising a monomer and at least one additional reactant comprising a branching agent and acrylic acid to form a polymer, wherein each of the reactions is performed under a different reaction condition selected from at least one of a composition of the reactants, concentration of the reactants, a feed rate of the reactants, a molecular weight of the reactants, or a reaction time;
measuring at least one property of the polymer selected from a molecular weight, degree of branching, polydispersity, solubility/flowability of the polymer, glass transition temperature, network formation, or gelation; and
selecting the reaction conditions that form the at least one property including flowability (no gelation).

20. The method of embodiment 19, wherein the additional reactants comprise at least one of a branching agent, a chain transfer agent, a linker, or a RAFT agent.

21. The method of embodiment 19 or 20, wherein at least one of the reaction conditions is fixed while the others are varied.

22. The method of any of the embodiments 19-21, wherein the monomer and/or reactant is a resin composition comprising monofunctional (meth)acrylic acid alkyl esters having alkyl, alkynyl or aryl groups of 1 to 18 carbon atoms or more and/or multifunctional (meth)acrylic acid alkyl esters having alkylene, alkynylene or arylene groups of 1 to 18 carbon atoms or less.

23. The method of embodiment 22, comprising selecting 70.0 mol % or more of monofunctional (meth)acrylic acid alkyl esters.

24. The method of embodiment 22 or 23, comprising selecting 20.0 mol % or less of multifunctional (meth)acrylic acid alkyl esters. The method further comprising selecting 10 mol % or less of (meth)acrylic acid.

25. The method of embodiment 23 comprising selecting the concentration of 70.0 mol %≤concentration ≤99.9 mol % of the monofunctional (meth)acrylic acid alkyl esters and/or a concentration of 0.01 mol %≤concentration ≤20.0 mol % of the multifunctional (meth)acrylic acid alkyl esters and/or a concentration of 0.01 mol %≤concentration ≤10.0 mol % of (meth)acrylic acid.

26. The method of any of the embodiments 19-25, wherein the at least one property comprises flowability of the solution formed by uniform dissolution of said resin composition in an organic solvent and comprising 1% to 80% by weight of the resin composition.

27. The method according to any of the embodiments 22-26, further comprising selecting the molecular weight of the resin composition comprising a weight average molecular weight Mw by GPC measurement as polystyrene equivalent between 0.5 kDa and 1000.0 kDa, and selecting the polydispersity (PDI) of the resin composition between 1.00 and 120.

28. The method of any of the embodiments 19-27, wherein the multifunctional (meth)acrylic acid alkyl ester is either ethylene glycol di(meth)acrylate or 2-(acryloyloxy)ethyl methacrylate (AEMA).

29. A method of making a polymer, comprising reacting 2902 the reactants screened and selected using the method of any of the embodiments 19-28 so as to form the polymer.

30. The method of embodiment 29, wherein the method comprises a Strathclyde method.

31. The method of embodiment 29 or 30, wherein the reaction is performed using a continuous flow capillary microreactor or a plug flow reactor.

32. The method of any of the embodiments 19-31, wherein the reactants comprise at least one of a (meth)acrylate monomer, a bis(meth)acrylate branching agent, a thiol chain-transfer agent (CTA), or a RAFT agent.

33. The method of embodiment 32, wherein the monomer comprises n-butyl acrylate.

34. The method of embodiment 32 or 33, wherein the reactants further comprise at least one branching agent or functional linker selected from ethylene glycol diacrylate (EGDA), ethylene glycol dimethacrylate (EGDMA), or 2-(acryloyloxy)ethyl methacrylate (AEMA).

35. The method of any of the embodiments 32-34, wherein the CTA comprises 1-dodecanethiol.

36. The method of any of the embodiments 32-34, wherein the RAFT agent comprises 2-(dodecylthiocarbonothioylthio)-2-methylpropionic acid (DDMAT) or a trithiocarbonate.

37. The resin composition of any of the embodiments 1-18 fabricated using the method of any of the embodiments 19-36.

38. The method of any of the embodiments 17, 18, or 29-37 wherein less than 50% of the solvent by volume is used in the polymerization of the resin composition.

39. The method of any of the embodiments 17, 18 or 29-38 wherein the manufacturing or reacting or synthesis comprises a continued plug flow process.

40. The method of any of the embodiments 17, 18, or 29-38 wherein the manufacturing or reacting or synthesis comprises a high throughput process.

41. The method of any of the embodiments 19-40 performed using a high throughput automated synthesis platform.

42. The method of any of the embodiments 19-40 further comprising the training 2900 of a machine learning model or algorithm (e.g., neural network) using the selected reaction conditions that form the at least one property including flowability (no gelation), so that the machine learning model may predict or determine new or additional reaction conditions, e.g., for the same or a different combination (e.g., composition) and/or concentration of the monomer and/or the additional reactants that form the resin composition that is a solution or a gel.

43. A method of manufacturing a resin composition, comprising
Predicting 2900, using a trained machine learning model (e.g., as trained using the method of embodiment 42), reaction conditions for polymerizing a monomer in a presence of one or more reactants to form a polymer comprising a solution that exhibits flowability (no gelation).

44. The method of embodiment 42 or 43, wherein the machine learning model predicts the reaction conditions to synthesize the resin composition with the highest molecular weight that does not form the resin composition as gel (i.e., that forms the resin composition that can be dissolved in a solvent (e.g., organic solvent), e.g., to form a homogeneous solution). In one or more examples, the machine learning model predicts the reaction conditions that define the boundary between gelation and solution formation.

45. The resin composition according to any of the embodiments 1-16, further comprising 0.1 wt % to 5 wt % of a physical crosslinker. In one or more examples, the physical crosslinker is aluminum acetylacetonate (Al(acac)₃).

46. The resin composition according to any of the embodiments 1-16 or 46, wherein a viscosity of the resin composition by flow sweep tests is less than 1×10⁴ Pa·s (pascal-seconds), or less than 5×10³ Pa·s, or less than 1×10³ Pa·s, or less than 5·10² Pa·s.

47. The resin composition according to any of the embodiments 1-16 or 46-47, wherein a peel force of the resin composition by 180° peel tests is more than 50 mN/25 mm, or more than 0.5 N/25 mm, or more than 1 N/25 mm, or more than 5 N/25 mm.

48. The resin composition of any of the embodiments 1-16, 18, 45-47, 50-52 fabricated using the method of any of the embodiments 17, 19-44

49. A system for synthesizing a resin composition (e.g., of any of the embodiments 1-16, 18 or 45-48, 50-61) comprising a reactor (e.g., flow reactor 1200 or batch synthesis reactor) or automated synthesis platform 110 for controlling the high throughput synthesis, for reacting the monomer and the additional reactants to form the resin composition comprising a polymer and a computer 2700 for automatically controlling the synthesis and reaction conditions according to the method of any of the embodiments 17, 19-44.

50. The resin composition according to any of the embodiments 1-16, 17, 45-48 wherein the resin composition is gel-free according to a standard gel content measurement.

51. The resin composition according to any of the embodiments 1-16, 17, 45-48, wherein the resin composition is characterized by a partial adhesive failure in a 180° Peel Test.

52. The resin composition according to any of the embodiments 1-16, 17, 45-48, wherein the resin composition is characterized by a cohesive failure in a 180° Peel Test.

53. As used throughout this disclosure, and in any of the embodiments 1-52, (meth)acrylate is defined to comprise a methacrylate or am acrylate, so that monofunctional (meth)acrylic acid alkyl esters can comprise a methacrylic acid alkyl ester or an acrylic acid alkyl ester, the multifunctional (meth)acrylic acid alkyl ester can comprise a methacrylic acid alkyl ester or an acrylic acid alkyl ester, and the (meth)acrylic acid can comprise methacrylic acid or an acrylic acid.

54. The resin composition of any of the embodiments 1-53, of the structure:

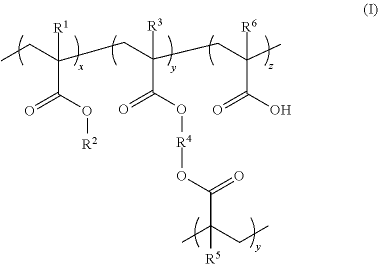

wherein
70.0 mol %≤x≤99.9 mol %,
0.01 mol %≤y≤20 mol %,
z≤10 mol %,
R¹, R³, R⁵, and R⁶ are each independently a hydrogen atom or a methyl group,
R² is an alkyl, alkenyl, or aryl group having 1 to 18 carbon atoms, and
R⁴ is a group having 1 to 18 carbon atoms or having 1 to 6 (meth)acryloyl groups.

55. The resin composition of embodiment 54, wherein the monofunctional (meth)acrylic acid alkyl ester units are each of n-butyl acrylate (nBA) and the multifunctional (meth)acrylic acid alkyl ester units are each of ethylene glycol diacrylate, ethylene glycol dimethacrylate, 2-acryloyloxyethyl methacrylate, pentaerythritol triacrylate, pentaerythritol tetraacrylate or dipentaerythritol pentaacrylate.

56. The resin composition of any of the embodiments 1-55 further comprising the solution comprising the resin composition and a metal salt, wherein the metal salt comprises 0.05% to 5% or 10% or less of the resin composition by weight.

57. The resin composition of any of the embodiments 1-56 further comprising a crosslinker crosslinking the sidechains of the resin compound.

58. A resin composition of the structure:

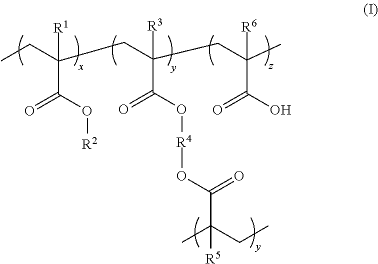

wherein
70.0 mol %≤x≤99.9 mol %,
0.01 mol %≤y≤20 mol %,
z≤10 mol %,
R¹, R³, R⁵ and R⁶ are each independently a hydrogen atom or a methyl group,
R² is an alkyl, alkenyl, or aryl group having 1 to 18 carbon atoms, and
R⁴ is a group having 1 to 18 carbon atoms or having 1 to 6 (meth)acryloyl groups.

59. The resin composition of embodiment 58, further comprising a cross-linker crosslinking the side-chains of the resin compound.

60 The resin composition of embodiment 58 or 59 synthesized using the method embodiment 17 or any of the embodiments 19-44.

61. The resin composition of embodiment 58-60 further comprising the features of any of the embodiments 1-16 or 45-57.

### Advantages and Improvements

The finding presented in this report have demonstrated the efficacy of high throughput screening in optimizing the synthesis of highly branched polymer via the Strathclyde method. The Chemspeed automated synthesis platform facilitates efficient exploration of a range of polymerization variables, including concentrations, feed ratios, types of branching agents and CTAs, and reaction time. The results revealed clear trends of gelation boundary and molecular weight changes with good reproducibility. The optimized conditions could be translated into continuous flow synthesis, further advancing the application of high throughput screening in developing enhanced polymer synthesis methodologies.

Moreover, the range of monomer types defined in claim 1 is different with the monomers used in previous work. Mostly, methyl methacrylate was used as the monomer previously which led to high polymer glass transition temperature above room temperature. Example monomers used in the invention such as butylacrylate have long alkyl chains, so that the Tg range of the resulting resin composition defined in claim 1 can be below 0° C., or below −50° C., to render them suitable as adhesive materials.

Provided and disclosed herein are resin compositions that exhibit excellent solubility in various organic solvents and whose solutions have flowability, or adhesives comprising such resin compositions. Generally, conventional resin compositions consisting of monofunctional (meth)acrylic esters and polyfunctional (meth)acrylic esters do not dissolve homogeneously in organic solvents due to gelation. In contrast, the resin compositions disclosed and claimed herein form a hyperbranched polymer rather than a gel, so they dissolve homogeneously in the solvent and the solution is fluid and thus can be applied to adhesives.

In one or more embodiments, monofunctional and multifunctional (meth)acrylic acid alkyl esters were chosen because their good UV/light stability over other monomers. Using the same type of monofunctional and multifunctional monomers, e.g. both (meth)acrylic alkyl esters, have the benefit of uniform reactivity and more well-defined product polymers. In some embodiments, alkylthiols with a long alkyl chain like 1-dodecanethiol was used as CTA because they are less toxic/smelly and have better solubility in the reaction solution.

### Possible Modifications

Efficient condition optimization for the synthesis of highly branched polymers using high throughput screening has been developed. This innovation allows rapid production of soluble, highly branched polymers with different properties (molecular weight, degree of branching, etc.). However, this versatile technique has the potential to be extended to other monomer/linker systems and polymerization techniques such as emulsion or suspension polymerization, anionic polymerization and continuous flow synthesis.

### Hardware Environment

FIG. 27 is an exemplary hardware and software environment 2700 (referred to as a computer-implemented system and/or computer-implemented method) used to implement one or more embodiments of the invention. The hardware and software environment includes a computer 2702 and may include peripherals. Computer 2702 may be a user/client computer, server computer, or may be a database computer, e.g., connected to a synthesis system for batch synthesis or a flow system 2750, 1200 for controlling the synthesis system, or connect to an automated synthesis platform 110 for controlling the high throughput synthesis. The computer 2702 comprises a hardware processor 2704A and/or a special purpose hardware processor 2704B (hereinafter alternatively collectively referred to as processor 2704) and a memory 2706, such as random access memory (RAM). The computer 2702 may be coupled to, and/or integrated with, other devices, including input/output (I/O) devices such as a keyboard 2714, a cursor control device 2716 (e.g., a mouse, a pointing device, pen and tablet, touch screen, multi-touch device, etc.) and a printer 2728. In one or more embodiments, computer 2702 may be coupled to, or may comprise, a portable or media viewing/listening device 2732 (e.g., an MP3 player, IPOD, NOOK, portable digital video player, cellular device, personal digital assistant, etc.). In yet another embodiment, the computer 2702 may comprise a multi-touch device, mobile phone, gaming system, internet enabled television, television set top box, or other internet enabled device executing on various platforms and operating systems.

In one embodiment, the computer 2702 operates by the hardware processor 2704A performing instructions defined by the computer program 2710 (e.g., machine learning application) under control of an operating system 2708. The computer program 2710 and/or the operating system 2708 may be stored in the memory 2706 and may interface with the user and/or other devices to accept input and commands and, based on such input and commands and the instructions defined by the computer program 2710 and operating system 2708, to provide output and results.

Output/results may be presented on the display 2722 or provided to another device for presentation or further processing or action.

Some or all of the operations performed by the computer 2702 according to the computer program 2710 instructions may be implemented in a special purpose processor 2704B. In this embodiment, some or all of the computer program 2710 instructions may be implemented via firmware instructions stored in a read only memory (ROM), a programmable read only memory (PROM) or flash memory within the special purpose processor 2704B or in memory 2706. The special purpose processor 2704B may also be hardwired through circuit design to perform some or all of the operations to implement the present invention. Further, the special purpose processor 2704B may be a hybrid processor, which includes dedicated circuitry for performing a subset of functions, and other circuits for performing more general functions such as responding to computer program 2710 instructions. In one embodiment, the special purpose processor 2704B is an application specific integrated circuit (ASIC), a field programmable gate array, or a processor configured for implementing artificial intelligence or machine learning, e.g., AI accelerator, neural processing unit (NPU), or graphics processing unit (GPU).

The computer 2702 may also implement a compiler 2712 that allows an application or computer program 2710 written in a programming language such as C, C++, Assembly, SQL, PYTHON, PROLOG, MATLAB, RUBY, RAILS, HASKELL, or other language to be translated into processor 2704 readable code. Alternatively, the compiler 2712 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 2710 accesses and manipulates data accepted from I/O devices and stored in the memory 2706 of the computer 2702 using the relationships and logic that were generated using the compiler 2712.

The computer 2702 also optionally comprises an external communication device such as a modem, satellite link, Ethernet card, or other device for accepting input from, and providing output to, other computers 2702.

In one embodiment, instructions implementing the operating system 2708, the computer program 2710, and the compiler 2712 are tangibly embodied in a non-transitory computer-readable medium, e.g., data storage device 2720, which could include one or more fixed or removable data storage devices, such as a zip drive, floppy disc drive 2724, hard drive, CD-ROM drive, tape drive, etc. Further, the operating system 2708 and the computer program 2710 are comprised of computer program 2710 instructions which, when accessed, read and executed by the computer 2702, cause the computer 2702 to perform the steps necessary to implement and/or use the present invention or to load the program of instructions into a memory 2706, thus creating a special purpose data structure causing the computer 2702 to operate as a specially programmed computer executing the method steps described herein. Computer program 2710 and/or operating instructions may also be tangibly embodied in memory 2706 and/or data communications devices 2730, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 2702.

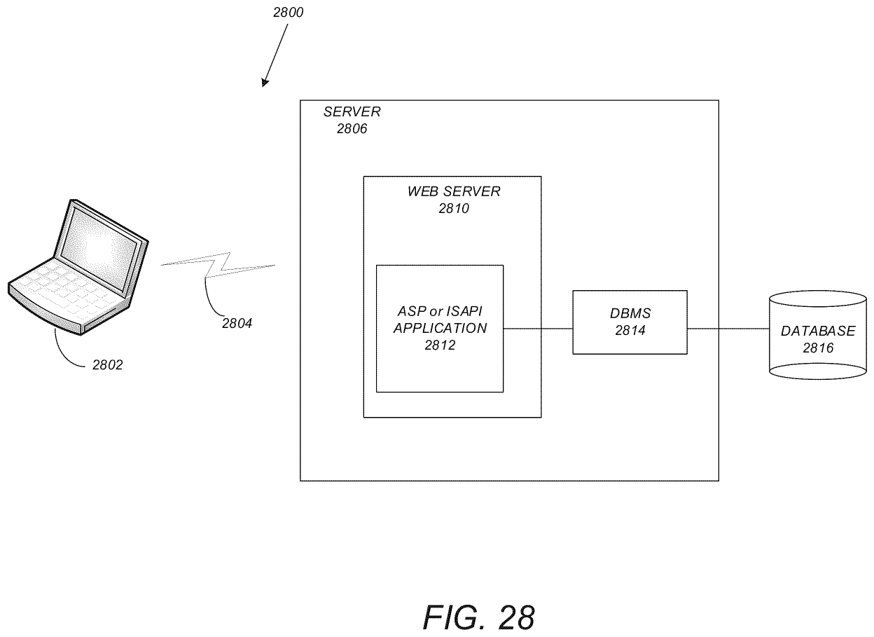

FIG. 28 schematically illustrates a typical distributed/cloud-based computer system 2800 using a network 2804 to connect client computers 2802 to server computers 2806. A typical combination of resources may include a network 2804 comprising the Internet, LANs (local area networks), WANs (wide area networks), SNA (systems network architecture) networks, or the like, clients 2802 that are personal computers or workstations (as set forth in FIG. 27), and servers 2806 that are personal computers, workstations, minicomputers, or mainframes (as set forth in FIG. 27). However, it may be noted that different networks such as a cellular network (e.g., GSM [global system for mobile communications] or otherwise), a satellite based network, or any other type of network may be used to connect clients 2802 and servers 2806 in accordance with embodiments of the invention.

A network 2804 such as the Internet connects clients 2802 to server computers 2806. Network 2804 may utilize ethernet, coaxial cable, wireless communications, radio frequency (RF), etc. to connect and provide the communication between clients 2802 and servers 2806. Further, in a cloud-based computing system, resources (e.g., storage, processors, applications, memory, infrastructure, etc.) in clients 2802 and server computers 2806 may be shared by clients 2802, server computers 2806, and users across one or more networks. Resources may be shared by multiple users and can be dynamically reallocated per demand. In this regard, cloud computing may be referred to as a model for enabling access to a shared pool of configurable computing resources.

Clients 2802 may execute a client application or web browser and communicate with server computers 2806 executing web servers 2810. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 2802 may be downloaded from server computer 2806 to client computers 2802 and installed as a plug-in or ACTIVEX control of a web browser. Accordingly, clients 2802 may utilize ACTIVEX components/component object model (COM) or distributed COM (DCOM) components to provide a user interface on a display of client 2802. The web server 2810 is typically a program such as MICROSOFT'S INTERNET INFORMATION SERVER.

Web server 2810 may host an Active Server Page (ASP) or Internet Server Application Programming Interface (ISAPI) application 2812, which may be executing scripts. The scripts invoke objects that execute business logic (referred to as business objects). The business objects then manipulate data in database 2816 through a database management system (DBMS) 2814. Alternatively, database 2816 may be part of, or connected directly to, client 2802 instead of communicating/obtaining the information from database 2816 across network 2804. When a developer encapsulates the business functionality into objects, the system may be referred to as a component object model (COM) system. Accordingly, the scripts executing on web server 2810 (and/or application 2812) invoke COM objects that implement the business logic. Further, server 2806 may utilize MICROSOFT'S TRANSACTION SERVER (MTS) to access required data stored in database 2816 via an interface such as ADO (Active Data Objects), OLE DB (Object Linking and Embedding DataBase), or ODBC (Open DataBase Connectivity).

Generally, these components 2800-2816 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 2802 and 2806 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 2802 and 2806. Embodiments of the invention are implemented as a software application on a client 2802 or server computer 2806. Further, as described above, the client 2802 or server computer 2806 may comprise a thin client device or a portable device that has a multi-touch-based display.

### REFERENCES

The following publications are incorporated by reference herein:
1. Polymer 2000, 41, 6027-6031.
2. Mater. Chem., 2003, 13, 2701-2710.
3. Macromolecules 2005, 38, 2131-2136.
4. Reactive & Functional Polymers 68 (2008) 1524-1533
5. J. Mater. Chem., 2003, 13, 2711-2720
6. Macromolecules 2004, 37, 2096-2105
7. Macromolecules 2006, 39, 5230-5237
8. J. Mater. Chem., 2007, 17, 545-552|545
9. Polym. Chem., 2011, 2, 941
10. Ind. Eng. Chem. Res. 2019, 58, 21312-21322
11. Macromolecules 2005, 38, 2131-2136
12. Polym. Chem., 2015, 6, 7871-7880
13. Macromolecules 2016, 49, 9396-9405
14. https://www.sharedinstrumentation.ucsb.edu/instruments/biopacific-mip/chemspeed-robotic-polymer-synthesis-platform
15. https://bpm-wiki.cnsi.ucsb.edu/doku.php?id=chemspeed_automated_chemistry_platform
16. https://biopacificmip.org/platform/instrumentation/chemspeed-robotic-polymer-synthesis-platform

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A resin composition, comprising:
70.0 mol % or more of monofunctional (meth)acrylic acid alkyl esters;
20.0 mol % or less of multifunctional (meth)acrylic acid alkyl esters or a multifunctional vinyl compound,
0 or 0.01 mol % to 5 mol % or 10 mol % of (meth)acrylic acid, wherein:
a glass transition temperature of said resin composition is from −80° C. to 80° C.,
the resin composition is characterized by uniform dissolution of said resin composition in an organic solvent to form a solution comprising 1% to 80% by weight of the resin composition.

2. The resin composition of claim 1 wherein:
one or more of the monofunctional (meth)acrylic acid alkyl esters comprise alkyl, alkynyl or aryl groups of one or more carbon atoms, and/or
one or more of the multifunctional (meth)acrylic acid alkyl esters comprise alkylene, alkynylene or arylene groups of 18 carbon atoms or less.

3. The resin composition of claim 1, further comprising 99.9 mol % or more of the monofunctional (meth)acrylic acid alkyl esters and 0.01 mol % or less of the multifunctional (meth)acrylic acid alkyl esters.

4. The resin composition of claim 1, wherein one or more of the monofunctional (meth)acrylic acid alkyl esters comprise 1≤number of carbon atoms ≤18 and one or more the multifunctional (meth)acrylic acid alkyl esters comprise 1≤number of carbon atoms ≤18.

5. The resin composition of claim 1, wherein the monofunctional and/or multifunctional (meth)acrylate acid alkyl esters comprise 2 or more carbons in the alkyl groups.

6. The resin composition of claim 1, wherein the multifunctional (meth)acrylate acid alkyl esters comprise asymmetric multifunctional (meth)acrylate acid alkyl esters.

7. The resin composition of claim 1, wherein the dissolution of the resin composition in the organic solvent forms composition polymers having a molecular weight larger than 70 kDa.

8. The resin composition of claim 1, wherein less than 50% of the solvent by volume is used in the polymerization of the resin composition in the solvent.

9. The resin composition of claim 1, further comprising 0.1 mol % to 10 mol % of (meth)acrylic acid.

10. The resin composition of claim 1, wherein a weight average molecular weight Mw of the resin composition by Gel Permeation Chromatography (GPC) measurement as polystyrene equivalent is between 0.5 kDa and 1000.0 kDa, and the polydispersity (PDI) is between 1.00 and 120.

11. The resin composition according to claim 1, wherein the multifunctional (meth)acrylic acid alkyl ester is either ethylene glycol di(meth)acrylate or 2-(acryloyloxy)ethyl methacrylate (AEMA).

12. The resin composition of claim 1, wherein the solution comprises a liquid and/or the solution of the resin composition shows or is characterized by flowability when the displacement of the sample solution is not zero when 1 g of the sample solution is taken in a vial and the vial is placed upside down and allowed to stand for 1 hour.

13. An adhesive comprising the resin composition according to claim 1.

14. The adhesive of claim 14 that exhibits adhesive strength between 0.1 N/25 mm and 50 N/25 mm in a 180° peel test.

15. The resin composition of claim 1, of the structure: 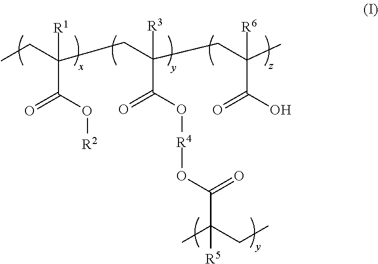
wherein
70.0 mol %≤x≤99.9 mol %,
0.01 mol %≤y≤20 mol %,
z≤10 mol %,
R¹, R³, R⁵, and R⁶ are each independently a hydrogen atom or a methyl group,
R² is an alkyl, alkenyl, or aryl group having 1 to 18 carbon atoms, and
R⁴ is a group having 1 to 18 carbon atoms or having 1 to 6 (meth)acryloyl groups.

16. The resin composition of claim 15, wherein the monofunctional (meth)acrylic acid alkyl ester units are each of n-butyl acrylate (nBA) and the multifunctional (meth)acrylic acid alkyl ester units are each of ethylene glycol diacrylate, ethylene glycol dimethacrylate, 2-acryloyloxyethyl methacrylate, pentaerythritol triacrylate, pentaerythritol tetraacrylate or dipentaerythritol pentaacrylate.

17. The resin composition of claim 1 further comprising the solution comprising the resin composition and a metal salt, wherein the metal salt comprises 0.05% to 5% or 10% or less of the resin composition by weight.

18. The resin composition of claim 15 further comprising a crosslinker crosslinking the sidechains of the resin compound.

19. A resin composition of the structure: 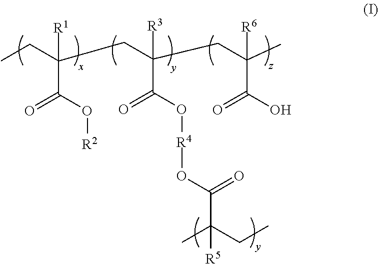
wherein
70.0 mol %≤x≤99.9 mol %,
0.01 mol %≤y≤20 mol %,
z≤10 mol %,
R¹, R³, R⁵ and R⁶ are each independently a hydrogen atom or a methyl group,
R² is an alkyl, alkenyl, or aryl group having 1 to 18 carbon atoms, and
R⁴ is a group having 1 to 18 carbon atoms or having 1 to 6 (meth)acryloyl groups.

20. The resin composition of claim 19, further comprising a cross-linker crosslinking the side-chains of the resin compound.
